(19) United States
(12) Patent Application Publication
(10) Pub. No.: US 2012/0161505 A1
(43) Pub. Date: Jun. 28, 2012

(54) BRAKE CONTROL APPARATUS

(75) Inventor: Kotaro Koyama, Isehara-shi (JP)

(73) Assignee: Hitachi Automotive Systems, Ltd.

(21) Appl. No.: 13/277,241

(22) Filed: Oct. 20, 2011

(30) Foreign Application Priority Data
Dec. 24, 2010 (JP) 2010-288392

(51) Int. Cl. B60T 8/00; B60L 7/00

(52) U.S. Cl. 303/9.62

(57) ABSTRACT

A brake control apparatus for a vehicle having a regenerative braking system, has a pump, a first brake circuit connecting a master cylinder and a wheel cylinder, a second brake circuit, a gate-out valve, a third brake circuit, an inflow valve, a fourth brake circuit connecting a point positioned at the wheel cylinder side with respect to the inflow valve and the pump, an outflow valve, a reservoir, a fluid suction part into which the brake fluid flows, a cut-off valve, a check valve, a branch oil passage connecting to the fluid suction part, a fifth brake circuit connecting to the reservoir, a stroke simulator valve regulating brake fluid amount flowing into the reservoir from the master cylinder, and a hydraulic pressure control unit. The hydraulic pressure control unit controls brake fluid pressure by operating each valve and the pump according to regenerative operation state of the regenerative braking system.

### BACKGROUND OF THE INVENTION

The present invention relates to a brake control apparatus.

A related art brake control apparatus has been disclosed in, for example, Japanese Patent Provisional Publication No. 2002-255018 (hereinafter is referred to as “JP2002-255018”).

In a related art brake control apparatus in JP2002-255018, during execution of a regenerative brake cooperative control, brake fluid that flows out from a master cylinder is sucked or absorbed into a stroke simulator, thereby generating pedal feel.

### SUMMARY OF THE INVENTION

In the related art brake control apparatus, however, there are still needs for further improvement in the pedal feel upon the execution of the regenerative brake cooperative control.

It is therefore an object of the present invention to provide a brake control apparatus that is capable of improving the pedal feel upon the execution of the regenerative brake cooperative control.

According to one aspect of the present invention, a brake control apparatus used for a vehicle having a regenerative braking system, comprises: a pump provided in a brake circuit; a first brake circuit connecting a master cylinder that generates a brake fluid pressure by driver's brake operation and a wheel cylinder that is configured so that the brake fluid pressure acts on; a second brake circuit connecting the first brake circuit and an outlet side of the pump; a gate-out valve provided at a master cylinder side with respect to a connection point of the second brake circuit, on the first brake circuit; a third brake circuit connecting a point positioned at the master cylinder side with respect to the gate-out valve and an inlet side of the pump, on the first brake circuit; an inflow valve provided at a wheel cylinder side with respect to the connection point of the second brake circuit, on the first brake circuit; a fourth brake circuit connecting a point positioned at the wheel cylinder side with respect to the inflow valve and the inlet side of the pump, on the first brake circuit; an outflow valve provided on the fourth brake circuit; a reservoir provided, on the fourth brake circuit, at the inlet side of the pump with respect to the outflow valve and connecting to the third brake circuit; a fluid suction part into which the brake fluid can flow; a cut-off valve provided between the master cylinder and the gate-out valve on the first brake circuit; a check valve arranged parallel to the cut-off valve and allowing only a flow of the brake fluid from the master cylinder; a branch oil passage branching off from a point between the cut-off valve and the gate-out valve and connecting to the fluid suction part; a fifth brake circuit branching off from a point between the master cylinder and the cut-off valve on the first brake circuit and connecting to the reservoir; a stroke simulator valve provided on the fifth brake circuit and regulating an amount of the brake fluid that flows into the reservoir from the master cylinder; and a hydraulic pressure control unit controlling the brake fluid pressure by operating the each valve and the pump in accordance with a regenerative operation state of the regenerative braking system.

According to another aspect of the present invention, a brake control apparatus used for a vehicle having a regenerative braking system, comprises: a pump provided in a brake circuit; a first brake circuit connecting a master cylinder that generates a brake fluid pressure by driver's brake operation and a wheel cylinder that is configured so that the brake fluid pressure acts on; a second brake circuit connecting the first brake circuit and an outlet side of the pump; a gate-out valve provided at a master cylinder side with respect to a connection point of the second brake circuit, on the first brake circuit; a third brake circuit connecting a point positioned at the master cylinder side with respect to the gate-out valve and an inlet side of the pump, on the first brake circuit; an inflow valve provided at a wheel cylinder side with respect to the connection point of the second brake circuit, on the first brake circuit; a fourth brake circuit connecting a point positioned at the wheel cylinder side with respect to the inflow valve and the inlet side of the pump, on the first brake circuit; an outflow valve provided on the fourth brake circuit; a reservoir provided, on the fourth brake circuit, at the inlet side of the pump with respect to the outflow valve and connecting to the third brake circuit; an accumulator into which the brake fluid can flow; a cut-off valve provided between the master cylinder and the gate-out valve on the first brake circuit; a check valve arranged parallel to the cut-off valve and allowing only a flow of the brake fluid from the master cylinder; a branch oil passage branching off from a point between the cut-off valve and the gate-out valve and connecting to the accumulator; a fifth brake circuit branching off from a point between the master cylinder and the cut-off valve on the first brake circuit and connecting to the reservoir; a stroke simulator valve provided on the fifth brake circuit and regulating an amount of the brake fluid that flows into the reservoir from the master cylinder; a fluid suction part opening/closing valve provided on the branch oil passage; and a hydraulic pressure control unit controlling the brake fluid pressure by operating the each valve and the pump in accordance with a regenerative operation state of the regenerative braking system, and when the regenerative braking system works, the brake fluid flowing out from the master cylinder by the driver's brake operation is stored in the accumulator by a pump operation of the pump through the fifth brake circuit, the stroke simulator valve, the fluid suction part opening/closing valve, the reservoir, the second brake circuit, the gate-out valve, the first brake circuit and the branch oil passage.

According to a further aspect of the invention, a brake control apparatus used for a vehicle having a regenerative braking system, comprises: a pump provided in a brake circuit; a first brake circuit connecting a master cylinder that generates a brake fluid pressure by driver's brake operation and a wheel cylinder that is configured so that the brake fluid pressure acts on; a second brake circuit connecting the first brake circuit and an outlet side of the pump; a gate-out valve provided at a master cylinder side with respect to a connection point of the second brake circuit, on the first brake circuit; a third brake circuit connecting a point positioned at the master cylinder side with respect to the gate-out valve and an inlet side of the pump, on the first brake circuit; an inflow valve provided at a wheel cylinder side with respect to the connection point of the second brake circuit, on the first brake circuit; a fourth brake circuit connecting a point positioned at the wheel cylinder side with respect to the inflow valve and the inlet side of the pump, on the first brake circuit; an outflow valve provided on the fourth brake circuit; a reservoir provided, on the fourth brake circuit, at the inlet side of the pump with respect to the outflow valve and connecting to the third brake circuit; a fluid suction part into which the brake fluid can flow; a cut-off valve provided between the master cylinder and the gate-out valve on the first brake circuit; a check valve arranged parallel to the cut-off valve and allowing only a flow of the brake fluid from the master cylinder; a branch oil passage branching off from a point between the cut-off valve and the gate-out valve and connecting to the fluid suction part; a fifth brake circuit branching off from a point between the master cylinder and the cut-off valve on the first brake circuit and connecting to the reservoir; a stroke simulator valve provided on the fifth brake circuit and regulating an amount of the brake fluid that flows into the reservoir from the master cylinder; a fluid suction part opening/closing valve provided on the branch oil passage; a first unit having a first housing that houses therein the cut-off valve, the fluid suction part, the fluid suction part opening/closing valve and the stroke simulator valve; and a second unit having a second housing that houses therein the gate-out valve, the pump, the inflow valve and the outflow valve, and the first unit and the second unit are connected at a point between the stroke simulator valve and the reservoir on the fifth brake circuit also at a point between a connection point of the first brake circuit with the third brake circuit and a connection point of the first brake circuit with the branch oil passage on the first brake circuit.

The other objects and features of this invention will become understood from the following description with reference to the accompanying drawings.

### BRIEF DESCRIPTION OF THE DRAWINGS

FIG. 1 is a system block diagram showing a brake system in a vehicle, using a brake control apparatus of an embodiment 1.

FIG. 2 is a hydraulic circuit of the brake control apparatus of the embodiment 1.

FIG. 3 is a hydraulic circuit showing a flow of brake fluid upon execution of a normal brake operation.

FIG. 4 is a time chart of each braking force upon execution of the normal brake operation.

FIG. 5 is a hydraulic circuit showing a flow of brake fluid upon execution of a regenerative brake cooperative control (the regenerative brake cooperative control is executed from the beginning of the braking).

FIG. 6 is a time chart of each braking force upon execution of the regenerative brake cooperative control (the regenerative brake cooperative control is executed from the beginning of the braking).

FIG. 7 is a hydraulic circuit showing a flow of brake fluid upon execution of the regenerative brake cooperative control (upon a brake shift from a friction braking force to a regenerative braking force).

FIG. 8 is a time chart of each braking force upon execution of the regenerative brake cooperative control (upon the brake shift from the friction braking force to the regenerative braking force).

FIG. 9 is a hydraulic circuit showing a flow of brake fluid upon execution of the regenerative brake cooperative control (upon a brake shift from a regenerative braking force to a friction braking force).

FIG. 10 is a time chart of each braking force upon execution of the regenerative brake cooperative control (upon a brake shift from a regenerative braking force to a friction braking force).

FIG. 11 is a hydraulic circuit showing a flow of brake fluid upon execution of the regenerative brake cooperative control (upon a further depression of a brake pedal).

FIG. 12 is a time chart of each braking force upon execution of the regenerative brake cooperative control (upon the further depression of the brake pedal).

FIG. 13 is a hydraulic circuit showing a flow of brake fluid upon execution of the regenerative brake cooperative control (the regenerative brake cooperative control is executed from the beginning of the braking and the regenerative braking force is lacking for a required braking force).

FIG. 14 is a time chart of each braking force upon execution of the regenerative brake cooperative control (the regenerative brake cooperative control is executed from the beginning of the braking and the regenerative braking force is lacking for the required braking force).

FIG. 15 is a hydraulic circuit showing a flow of brake fluid upon execution of a pressure decrease command of an ABS control.

FIG. 16 is a time chart of each braking force upon execution of the pressure decrease command of the ABS control.

FIG. 17 is a hydraulic circuit showing a flow of brake fluid upon execution of a pressure increase command of the ABS control.

FIG. 18 is a hydraulic circuit showing a flow of brake fluid upon execution of a re-pressure decrease command of the ABS control.

FIG. 19 is a hydraulic circuit showing a flow of brake fluid upon execution of the pressure decrease command of the ABS control (decrease of the regenerative braking force is insufficient for decrease in the braking force).

FIG. 20 is a time chart of each braking force upon execution of the pressure decrease command of the ABS control (decrease of the regenerative braking force is insufficient for decrease in the braking force).

FIG. 21 is a hydraulic circuit showing a flow of brake fluid upon intervention of a brake assist control.

FIG. 22 is a time chart of each braking force upon intervention of the brake assist control.

FIG. 23 is a hydraulic circuit showing a flow of brake fluid upon intervention of the brake assist control (the regenerative braking force lowers).

FIG. 24 is a time chart of each braking force upon intervention of the brake assist control (the regenerative braking force lowers).

FIG. 25 is a hydraulic circuit showing a flow of brake fluid upon intervention of the brake assist control (upon a pressure decrease).

FIG. 26 is a time chart of each braking force upon intervention of the brake assist control (upon the pressure decrease).

FIG. 27 is a hydraulic circuit showing a flow of brake fluid upon intervention of a vehicle behavior stabilization control.

FIG. 28 is a time chart of each braking force upon intervention of the vehicle behavior stabilization control.

FIG. 29 is a hydraulic circuit showing a flow of brake fluid upon intervention of the vehicle behavior stabilization control (a fluid suction part is empty).

FIG. 30 is a time chart of each braking force upon intervention of the vehicle behavior stabilization control (the fluid suction part is empty).

### DETAILED DESCRIPTION OF THE INVENTION

Embodiments of a brake control apparatus of the present invention will be explained below with reference to the drawings.

The embodiments explained below are designed to meet various needs. The improvement of the pedal feel upon the execution of the regenerative brake cooperative control is one of the various needs. The following embodiments are also designed to meet the needs for improvement in a pressure increase response of a wheel cylinder and the needs for cost reduction.

### Embodiment 1

First, a system will be explained.

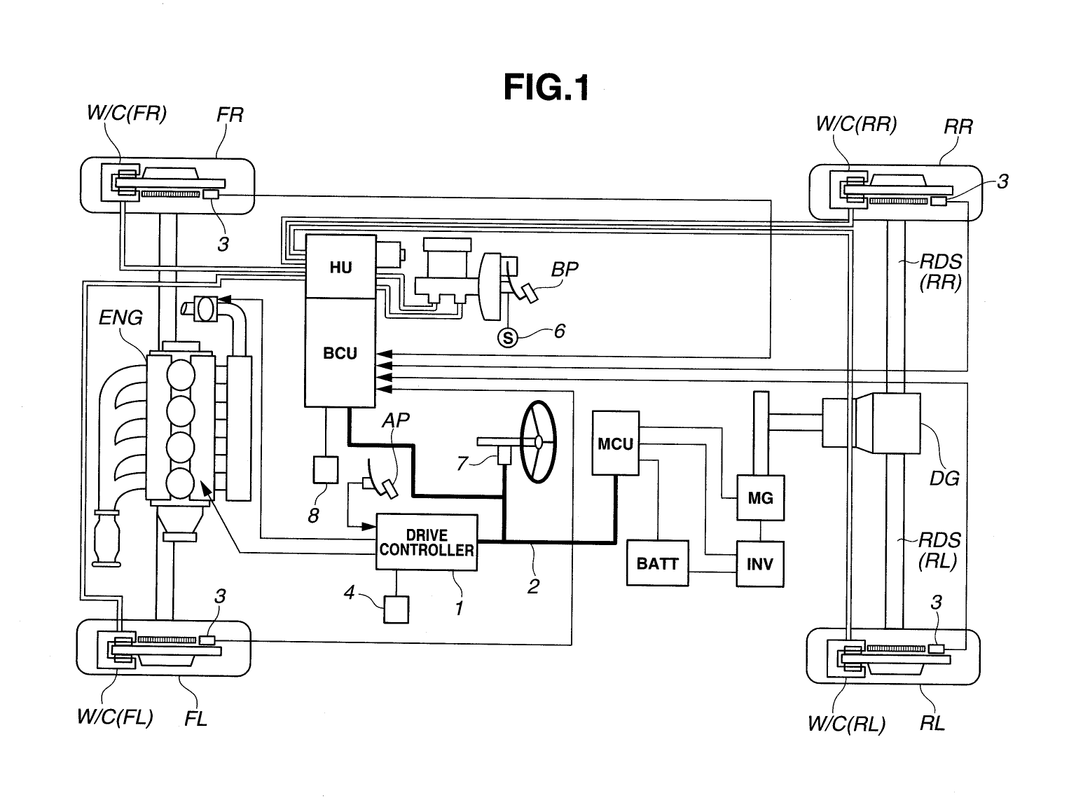

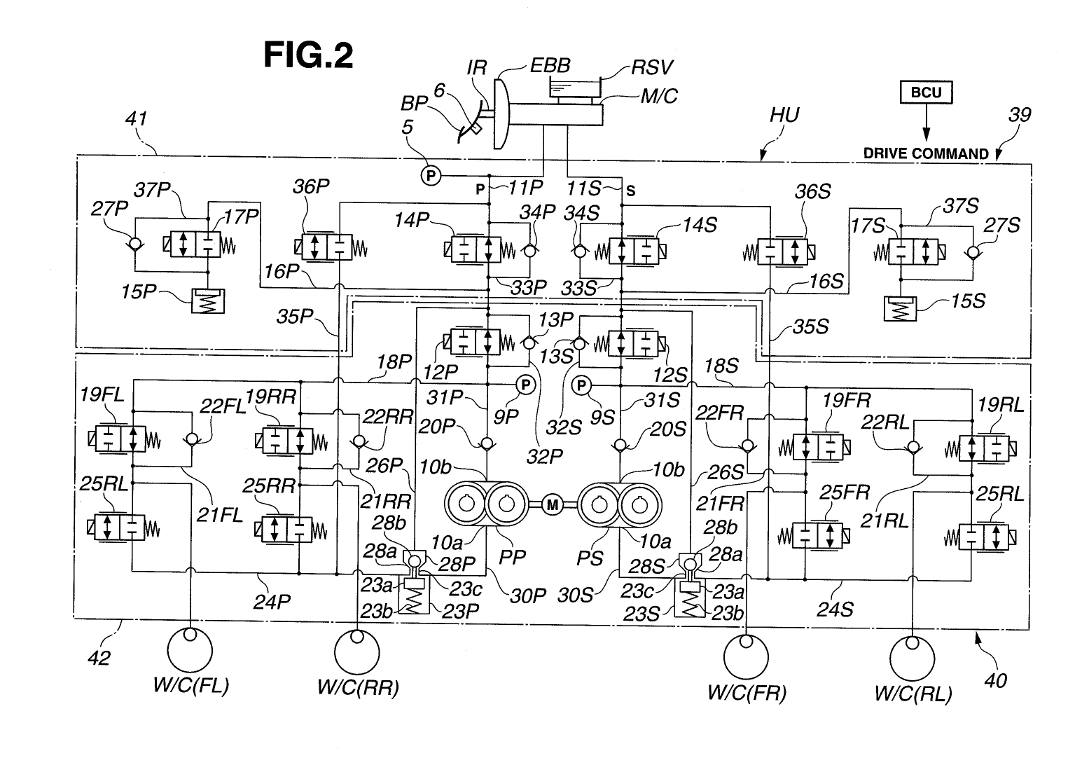

FIG. 1 is a system block diagram showing a brake and drive system in a vehicle, using a brake control apparatus of an embodiment 1. FIG. 2 is a hydraulic circuit of the brake control apparatus of the embodiment 1.

### [System Configuration]

A hydraulic pressure control unit HU increases or decreases or holds each hydraulic pressure of a wheel cylinder W/C (FL) of a front left wheel FL, a wheel cylinder W/C (RR) of a rear right wheel RR, a wheel cylinder W/C (FR) of a front right wheel FR and a wheel cylinder W/C (RL) of a rear left wheel RL, on the basis of a friction braking force command from a brake control unit (a hydraulic pressure control unit or section) BCU.

A motor/generator MG is a three-phase AC motor and is connected to rear drive shafts RDS (RL), RDS (RR) of the rear left and rear right wheels RL, RR through a differential gear DG. The motor/generator MG performs a power running operation or a regenerative operation and provides a driving force or a regenerative braking force to the rear wheels RL and RR on the basis of a command from a motor control unit MCU.

An inverter INV converts DC power of a battery BATT to AC power and supplies the power to the motor/generator MG on the basis of a drive command from the motor control unit MCU, then the power running operation of the motor/generator MG is carried out. On the other hand, the inverter INV converts AC power generated in the motor/generator MG to DC power and charges the battery BATT on the basis of a regenerative command from the motor control unit MCU, then the regenerative operation of the motor/generator MG is carried out.

The motor control unit MCU outputs the drive command to the inverter INV on the basis of a driving force command from a drive controller 1. Also the motor control unit MCU outputs the regenerative command to the inverter INV on the basis of a regenerative braking force command from the brake control unit (the hydraulic pressure control section) BCU.

The motor control unit MCU sends information of state of an output control of the driving force or the regenerative braking force by the motor/generator MG and a generatable maximum regenerative braking force at this time point to the brake control unit BCU and the drive controller 1 through a communication line 2. Here, with regard to the generatable maximum regenerative braking force, it is calculated from, for example, a battery SOC that is estimated from a terminal voltage and a current value of the battery BATT or a vehicle speed that is calculated (estimated) by a wheel speed sensor 3. Further, a steering characteristic of the vehicle is also taken into consideration when cornering.

That is, in a case where the battery BATT is in a fully charged state or an almost fully charged state, there is a need to prevent overcharging in terms of battery protection. Further, when the vehicle speed decreases by the braking, the generatable maximum regenerative braking force by the motor/generator MG is reduced. Furthermore, when performing the regenerative braking during a high speed running, a load of the inverter INV becomes high. Thus the maximum regenerative braking force is limited during the high speed running.

In addition, in the vehicle in the embodiment 1, because the regenerative braking force is applied to the rear wheels, in a case of an excess of the regenerative braking force relative to the friction braking force during the cornering, namely that when the braking force of the rear wheels is too great as compared with that of the front wheels during the cornering, the steering characteristic of the vehicle becomes an oversteer state, and cornering behavior is disrupted. Because of this, in a case where the tendency of the oversteer becomes stronger, it is required that the maximum regenerative braking force should be limited and an allocation of the braking force to the front and rear wheels during the cornering should be closer to an ideal allocation (e.g. front: rear=6:4) according to specifications of the vehicle.

A regenerative braking system that produces the regenerative braking force at the wheels (the rear left and rear right wheels RL, RR) is formed by the motor/generator MG, the inverter INV, the battery BATT and the motor control unit MCU.

The drive controller 1 inputs an accelerator opening from an accelerator opening sensor 4, the vehicle speed calculated by the wheel speed sensor 3, the battery SOC and so on, directly or through the communication line 2.

The drive controller 1 carries out an operation control of an engine ENG, an operation control of an automatic transmission (not shown) and an operation control of the motor/generator MG by the driving force command to the motor control unit MCU, on the basis of information from each sensor.

The brake control unit BCU inputs a brake fluid pressure from a first pressure sensor 5, a brake pedal stroke amount from a brake pedal stroke sensor (a brake operation state detection section) 6, a steering angle from a steering angle sensor 7, each wheel speed from the wheel speed sensor 3, a yaw rate from a yaw rate sensor 8, a brake fluid pressure from a second pressure sensor 9, the battery SOC and so on, directly or through the communication line 2. The first pressure sensor 5 detects the brake fluid pressure at a point on a pipe 11 which is positioned at a master cylinder M/C side with respect to a connection point of the pipe 11 with a pipe 35, namely that the first pressure sensor 5 detects a master cylinder pressure. The second pressure sensor 9 detects a pressure of a pipe 31, namely that the second pressure sensor 9 detects a discharge pressure of a pump P.

The brake control unit BCU calculates the braking force (for each wheel) required for the braking of the vehicle on the basis of information from each sensor, and splits the required braking force between the regenerative braking force and the friction braking force, then performs an operation control of the hydraulic pressure control unit HU by the friction braking force command from the brake control unit BCU and an operation control of the motor/generator MG by the regenerative braking force command to the motor control unit MCU.

Here, in the embodiment 1, as the regenerative brake cooperative control, the regenerative braking force is used in preference to the friction braking force. As long as the required braking force can be covered by the regenerative braking force, a range of the regenerative braking is extended to the maximum (the maximum regenerative braking force) without using the friction braking force. With this, particularly in a drive pattern in which acceleration and deceleration are repeated, recovery of energy by the regenerative braking is realized up to a lower speed range, and energy-recovery efficiency becomes high.

In the case where the regenerative braking force is limited due to the decrease or the increase in the vehicle speed etc. during the regenerative braking, the brake control unit BCU decreases the regenerative braking force and increases the friction braking force by an amount of the decrease of the regenerative braking force, then secures the braking force required for the braking of the vehicle.

In the following description, an operation that decreases the regenerative braking force and increases the friction braking force is called “brake shift (or brake switch) from the regenerative braking force to the friction braking force”. An operation that decreases the friction braking force and increases the regenerative braking force is called “brake shift (or brake switch) from the friction braking force to the regenerative braking force”.

The brake control unit BCU directly increases the wheel cylinder pressure using hydraulic pressure generated by driver's brake operation (i.e. the BCU performs a normal brake operation), in addition to this, the brake control unit BCU performs a control that increases or decreases or holds the wheel cylinder pressure using a discharge pressure of a pump P. With this wheel cylinder pressure control, ABS control (anti-lock brake control) can be achieved. Further, an automatic brake control that automatically increases/decreases the wheel cylinder pressure on the basis of the braking force required for various vehicle control can also be achieved.

Here, the ABS control is a control that when detecting a tendency of wheel lock during the driver's brake operation, repeats the pressure decrease, the pressure hold and the pressure increase of the wheel cylinder pressure for this wheel in order to produce the maximum braking force while preventing the wheel lock.

Further, the automatic brake control includes a vehicle behavior stabilization control that when detecting that the tendency of the oversteer or the tendency of understeer becomes stronger during the cornering, ensures stabilization of a vehicle behavior by controlling the wheel cylinder W/C pressure of a certain wheel. Furthermore, a brake assist control in which a higher pressure than a pressure actually generated in the master cylinder M/C is produced at the wheel cylinder W/C upon the driver's brake operation, and a control that automatically produces the braking force in accordance with a relationship (e.g. vehicle speed, vehicle distance) with a forward-running vehicle by an auto cruise control, are included in the automatic brake control.

The brake control unit BCU has an anti-lock brake control section that performs the ABS control and a vehicle behavior stabilization control section that performs the vehicle behavior stabilization control.

[Brake Circuit Configuration]

Next, the hydraulic circuit of the hydraulic pressure control unit HU will be explained on the basis of FIG. 2. The hydraulic pressure control unit HU in the embodiment 1 has a so-called X-piping arrangement (x-pipe system) that is formed from two line pipes of a P line pipe and an S line pipe. In FIG. 2, “P” and “S” attached to the end of a reference sign indicate “P line system (P line pipe)” and “S line system (S line pipe)” respectively. FL, RR, FR and RL correspond to the front left wheel, the rear right wheel, the front right wheel and the rear left wheel respectively. In the following description, when explaining “P line system” and “S line system” and each wheel without distinction, “P” and “S” and FL, RR, FR and RL are omitted.

The hydraulic pressure control unit HU in the embodiment 1 employs a closed hydraulic circuit. Here, the closed hydraulic circuit is a hydraulic circuit in which brake fluid that is supplied to the wheel cylinder W/C is returned to a reservoir tank RSV via the master cylinder M/C.

A brake pedal BP is connected to the master cylinder M/C via an input rod IR. The input rod IR is provided with an electric booster EBB that boosts an input of the input rod IR. The electric booster EBB is a booster that produces a brake pressure in the master cylinder M/C by moving a booster rod (not shown) arranged parallel to the input rod IR by an electric motor in accordance with a stroke amount of the input rod IR.

The P line pipe is connected to the wheel cylinder W/C (FL) of the left front (FL) wheel and the wheel cylinder W/C (RR) of the right rear (RR) wheel. The S line pipe is connected to the wheel cylinder W/C (FR) of the right front (FR) wheel and the wheel cylinder W/C (RL) of the left rear (RL) wheel. As shown in FIG. 2, a pump PP is provided in the P line pipe, and a pump PS is provided in the S line pipe. The pump PP and the pump PS are, for example, a plunger pump or a gear pump etc. These pumps PP and PS are driven by one motor M, and pressurize the brake fluid that is pumped up from an inlet section 10a then discharge the brake fluid to an outlet section 10b.

The master cylinder M/C and the outlet section 10b of the pump P are connected by pipes 11 and 31. On the pipe 11, a gate-out valve 12 of a normally-open type proportional electromagnetic valve is provided. Here, the normally-open type valve is a valve that fully opens during non-power application and operates in a valve closing direction during the power application. Further, on the pipe 11, a pipe 32 that bypasses the gate-out valve 12 is provided.

On the pipe 32, a check valve 13 is provided. This check valve 13 allows a flow of the brake fluid in a direction from the master cylinder M/C toward the wheel cylinder W/C, and forbids a brake fluid flow of the opposite direction.

The pipe 31 is a second brake circuit that connects an after-mentioned first brake circuit (pipes 11 and 18) and the outlet section 10b of the pump P. On the pipe 31, a check valve 20 is provided. The check valve 20 allows a flow of the brake fluid in a direction from the pump P toward a solenoid-in valve 19, and forbids a brake fluid flow of the opposite direction.

On the pipe 11, a cut-off valve 14 of a normally-open type proportional electromagnetic valve is provided between the master cylinder M/C and the gate-out valve 12. Further, on the pipe 11, a pipe 33 that bypasses the cut-off valve 14 is provided.

On the pipe 33, a check valve 34 is provided. The check valve 34 allows a flow of the brake fluid in a direction from the master cylinder M/C toward the wheel cylinder W/C, and forbids a brake fluid flow of the opposite direction.

A pipe (a branch oil passage) 16 is provided on the pipe 11, and branches off from a point between the cut-off valve 14 and the gate-out valve 12. The pipe 16 connects to a fluid suction part 15. The fluid suction part 15 is an accumulator which has, for example, a gas spring and can store therein a high pressure brake fluid.

On the pipe 16, a fluid suction part opening/closing valve 17 of a normally-closed type electromagnetic valve is provided. Here, the normally-closed type valve is a valve that fully closes during non-power application and operates in a valve opening direction during the power application. Further, on the pipe 16, a pipe 37 that bypasses the fluid suction part opening/closing valve 17 is provided.

On the pipe 37, a check valve 27 is provided. This check valve 27 allows a flow of the brake fluid in a direction from the fluid suction part 15 toward the pipe 11, and forbids a brake fluid flow of the opposite direction.

The outlet section 10b of the pump P and the wheel cylinder W/C are connected by the pipe 18. On the pipe 18, the solenoid-in valve (an inflow valve) 19 of a normally-open type proportional electromagnetic valve is provided for each wheel cylinder W/C.

On the pipe 18, a pipe 21 that bypasses the solenoid-in valve 19 is provided. On this pipe 21, a check valve 22 is provided. The check valve 22 allows a flow of the brake fluid in a direction from the wheel cylinder W/C toward the pump P, and forbids a brake fluid flow of the opposite direction.

The pipe 18 connects to the connection point between the pipes 11 and 31, and the second pressure sensor 9 is provided at this connection point.

The pipes 11 and 18 form the first brake circuit. The first brake circuit connects the master cylinder M/C that generates the brake fluid pressure by the driver's brake operation and the wheel cylinder W/C that is configured so that the brake fluid pressure acts on.

A point between the master cylinder M/C and the cut-off valve 14 on the first brake circuit and a reservoir 23 are connected by a pipe 35. The pipe 35 is a fifth brake circuit that branches off from the point between the master cylinder M/C and the cut-off valve 14 on the first brake circuit and connects to the reservoir 23.

On the pipe 35, a stroke simulator valve 36 of a normally-closed type proportional electromagnetic valve, which regulates an amount of the brake fluid that flows into the reservoir 23 from the master cylinder M/C, is provided.

The wheel cylinder W/C and the reservoir 23 are connected by a pipe 24. On the pipe 24, a solenoid-out valve (an outflow valve) 25 of a normally-closed type proportional electromagnetic valve is provided.

The master cylinder M/C and the reservoir 23 are connected by a pipe 26. The pipe 26 is a third brake circuit that is on the first brake circuit (the pipes 11, 18) and connects a point positioned at the master cylinder M/C side with respect to the gate-out valve 12 and an inlet side (a pipe 30) of the pump P.

The reservoir 23 and the inlet section 10a of the pump P are connected by the pipe 30.

The pipes 24 and 30 form a fourth brake circuit. The fourth brake circuit is on the first brake circuit (the pipes 11, 18), and connects a point positioned at a wheel cylinder W/C side with respect to the solenoid-in valve 19 and the inlet section 10a of the pump P.

The reservoir 23 has a piston 23a and a gas spring (a spring member) 23b that forces the piston 23a. Further, the reservoir 23 is provided with a pressure-responsive check valve (a regulation valve or a control valve) 28 on the pipe 26.

The check valve 28 has a seat part 28a and a valve body 28b that is fixedly connected to the piston 23a. The seat part 28a is formed at an inlet portion 23c of the reservoir 23, and the valve body 28b is seated on the seat part 28a. When a predetermined amount of the brake fluid is stored in the reservoir 23, or when a pressure in the pipe 26 becomes a high pressure that exceeds a predetermined pressure, the valve body 28b is seated on the seat part 28a and closes the valve, then the check valve 28 forbids the inflow of the brake fluid into the reservoir 23. With this valve operation, application of high pressure to the inlet section 10a of the pump P is prevented.

When the pump P operates and the pressure in the pipe 30 becomes low, the valve body 28b is separated from the seat part 28a and opens the valve regardless of the pressure in the pipe 26. The check valve 28 then allows the inflow of the brake fluid into the reservoir 23.

The brake control unit BCU operates the gate-out valve 12, the cut-off valve 14, the fluid suction part opening/closing valve 17, the solenoid-in valve 19, the solenoid-out valve 25, the stroke simulator valve 36 and the pump P in accordance with a regenerative operation state of the regenerative braking system (the motor/generator MG, the inverter INV and the battery BATT), then controls the brake fluid pressure (the hydraulic pressure).

The hydraulic pressure control unit HU has a first unit 39 and a second unit 40. The first unit 39 is a unit that includes the cut-off valve 14, the fluid suction part 15, the fluid suction part opening/closing valve 17 and the stroke simulator valve 36 which are housed in a first housing 41. The second unit 40 is a unit that includes the gate-out valve 12, the pump P, the solenoid-in valve 19 and the solenoid-out valve 25 which are housed in a second housing 42.

The first unit 39 and the second unit 40 are connected at a point between the stroke simulator valve 36 and the reservoir 23 on the pipe 35, also at a point between a connection point of the pipe 11 with the pipe 26 and a connection point of the pipe 11 with the pipe 16 on the pipe 11.

Next, the operation will be explained.

In the following description, operation of each valve and the pump P in the hydraulic pressure control unit HU and its influence will be explained for each scene using a flow of the brake fluid in the hydraulic circuit and a time chart of each braking force. The flow of the brake fluid is indicated by a thick line and an arrow in the hydraulic circuit. In the explanation, as the hydraulic circuit, only the P line system is shown. However, except for a case where only one wheel cylinder pressure is increased/decreased, the same operation of each valve and the pump P in the S line system as that in the P line system is performed.

[Normal Brake Operation]

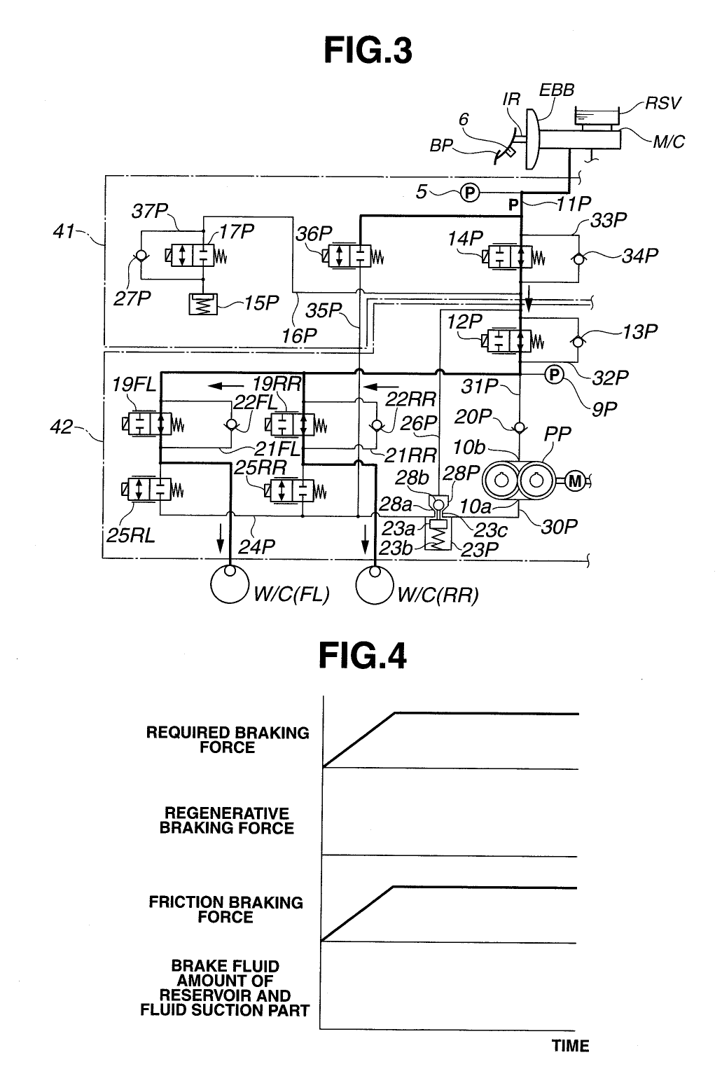

In the normal brake operation (the normal braking) in which there is no intervention of the regenerative brake cooperative control by the regenerative braking system also the automatic brake control such as the ABS control and the vehicle behavior stabilization control is not executed, in order to equalize both pressures of the master cylinder pressure detected by the first pressure sensor 5 and the wheel cylinder pressure detected by the second pressure sensor 9, each valve and the pump P are not operated (i.e. non-power application state). With this, as shown in FIG. 3, the brake fluid that flows into the hydraulic pressure control unit HU from the master cylinder M/C according to the driver's brake operation is supplied to the wheel cylinder W/C through the pipes 11 and 18, and the wheel cylinder pressure is increased. The required braking force is thus secured by only the friction braking force (FIG. 4).

[Regenerative Brake Cooperative Control]

In the regenerative brake cooperative control, the stroke simulator valve 36 and the cut-off valve 14 are used so that a relationship between the brake pedal stroke amount (a brake operation amount) detected by the brake pedal stroke sensor 6, the master cylinder pressure detected by the first pressure sensor 5 and a vehicle deceleration is always maintained at a constant or certain relationship (a brake pedal characteristic of the normal braking).

Unnecessary brake fluid of the wheel cylinder W/C side, which corresponds to a hydraulic pressure converted amount of the regenerative braking force, is pumped up from the reservoir 23 by the pump P then is stored in the fluid suction part 15.

When the regenerative braking force lowers, the wheel cylinder pressure is increased using the brake fluid stored in the fluid suction part 15.

(a) Regenerative brake cooperative control from the beginning of the braking (the regenerative braking force is produced from the beginning of the braking) (the required braking force≦the maximum regenerative braking force)

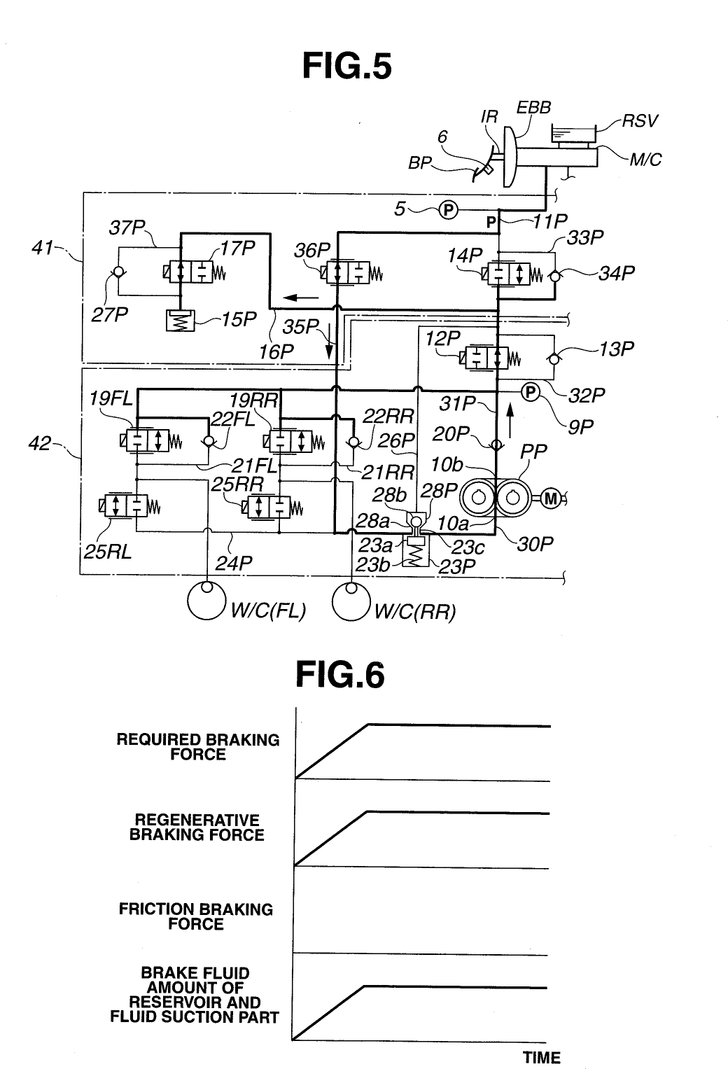

In a case where an intervention of the regenerative brake cooperative control is made from the beginning of the braking at which the driver starts depression of the brake pedal BP, the cut-off valve 14, the fluid suction part opening/closing valve 17, the solenoid-in valve 19, the stroke simulator valve 36 and the pump P are operated from the normal braking state of FIG. 3. By closing the cut-off valve 14 and the solenoid-in valve 19 and opening the stroke simulator valve 36, as shown in FIG. 5, the brake fluid flowing out from the master cylinder M/C flows into the reservoir 23. The brake fluid stored in the reservoir 23 is pumped up by operating the pump P, and is delivered to the fluid suction part 15. Therefore, generation of the friction braking force can be prevented, and the required braking force is produced by only the regenerative braking force, then an energy recovery efficiency can be increased (FIG. 6).

In this operation, proportional controls of the stroke simulator valve 36, the cut-off valve 14 and the pump P are performed so as to obtain a target master cylinder pressure. The target master cylinder pressure is set on the basis of the master cylinder pressure detected by the first pressure sensor 5 and the brake pedal stroke amount detected by the brake pedal stroke sensor 6 so as to be able to obtain the brake pedal characteristic of the normal braking. With this, good pedal feel same as the normal braking can be obtained. Here, the brake pedal characteristic could be generated by only the proportional control of the stroke simulator valve 36, and the proportional control of the cut-off valve 14 is performed so that the brake fluid does not return to the master cylinder M/C side.

(b) Brake Shift from the Friction Braking Force to the Regenerative Braking Force

In a case where the regenerative brake cooperative control (the regenerative braking) is permitted from a state, such as the high speed running and the cornering, in which the regenerative brake cooperative control is forbidden and only the friction braking force is generated, the cut-off valve 14, the fluid suction part opening/closing valve 17, the solenoid-in valve 19, the solenoid-out valve 25 and the pump P are operated from the normal braking state.

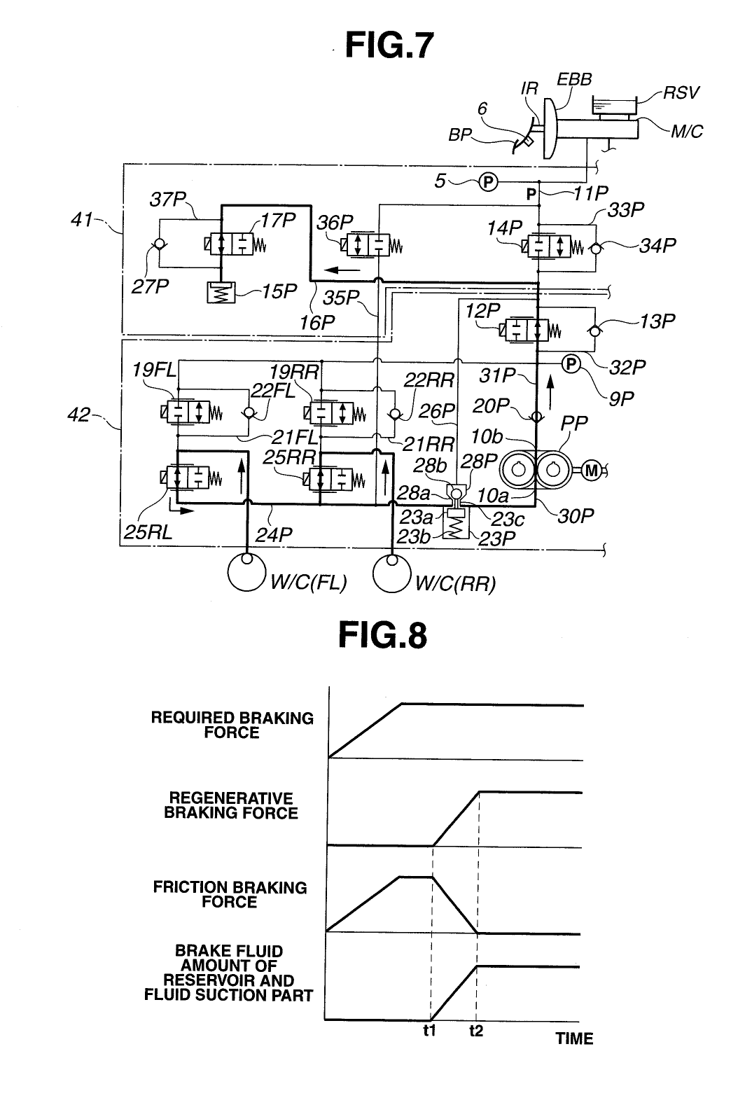

By opening the solenoid-out valve 25 by the proportional control, as shown in FIG. 7, the brake fluid of the wheel cylinder W/C flows out to the reservoir 23. The brake fluid flowing into the reservoir 23 is pumped up by the pump P, and is delivered to the fluid suction part 15. Thus, the brake shift from the friction braking force to the regenerative braking force can be achieved while securing the good pedal feel same as the brake pedal characteristic of the normal braking. The energy recovery efficiency can therefore be increased (a time period from time t1 to time t2 in FIG. 8).

(c) Brake Shift from the Regenerative Braking Force to the Friction Braking Force

In a case where the regenerative brake cooperative control is forbidden by a condition of the vehicle speed etc. during the execution of the regenerative brake cooperative control, the fluid suction part opening/closing valve 17 and the stroke simulator valve 36 are not operated from the state of (a). Further, the proportional control of the solenoid-in valve 19 is performed so that the friction braking force rises up or increases with the reduction of the regenerative braking force. The pump P is operated with consideration given to the storing of the brake fluid in the reservoir 23.

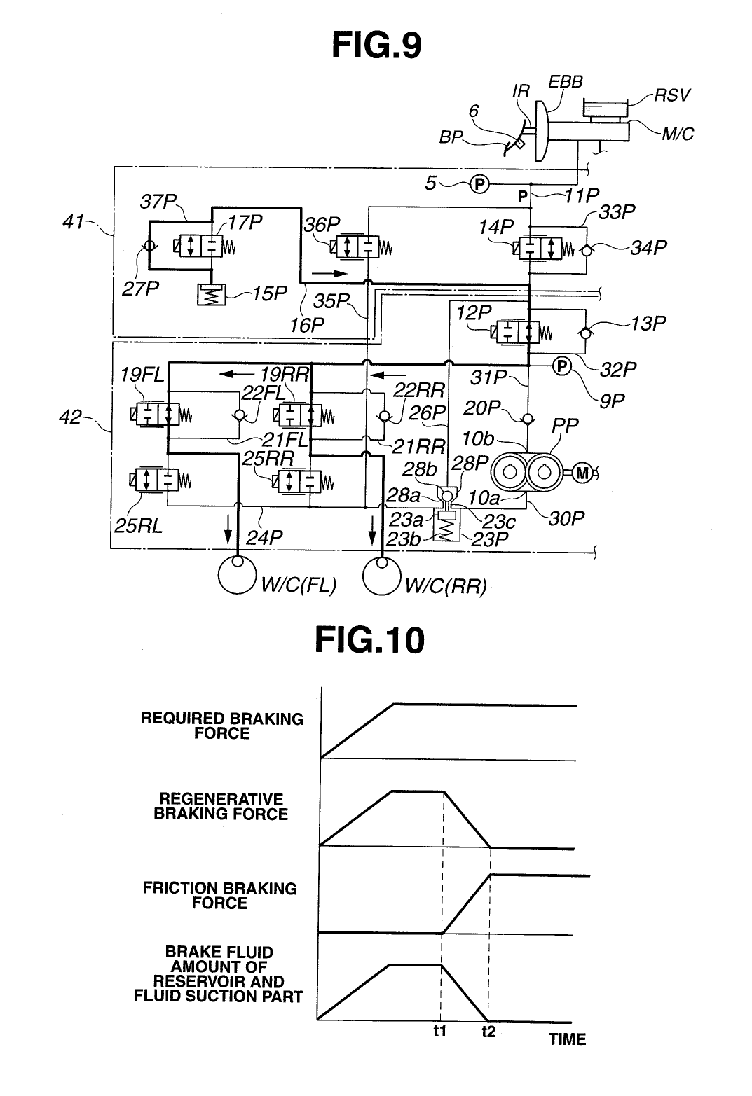

By opening the solenoid-in valve 19 by the proportional control, as shown in FIG. 9, the brake fluid stored in the fluid suction part 15 can be supplied to the wheel cylinder W/C, and the required braking force can be secured by the brake shift from the regenerative braking force to the friction braking force (a time period from time t1 to time t2 in FIG. 10). In addition, since the brake fluid stored in the fluid suction part 15 is the high pressure brake fluid, the fluid suction part 15 functions as a high pressure accumulator, and the friction braking force rises up immediately. Normally, a response of the friction braking force is low as compared with the regenerative braking force. However, as described above, the fluid suction part 15 functions as the high pressure accumulator, thereby suppressing lack of braking force upon the brake shift from the regenerative braking force to the friction braking force.

(d) Further Depression of the Brake Pedal During the Execution of the Regenerative Brake Cooperative Control

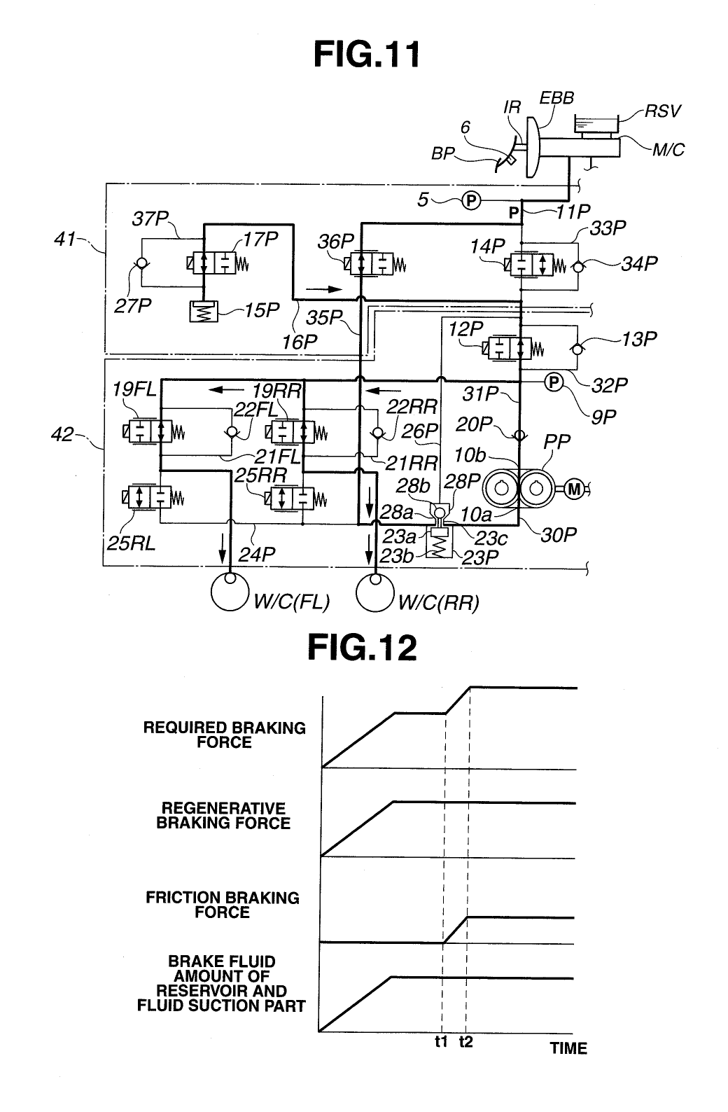

In a case where the further depression of the brake pedal BP is done by the driver during the execution of the regenerative brake cooperative control, the same operation as (a) is performed until the regenerative braking force reaches the maximum regenerative braking force. However, when the regenerative braking force reaches the maximum regenerative braking force, the proportional control of the solenoid-in valve 19 is performed in accordance with an amount of the further depression of the brake pedal BP. That is, in a case where the regenerative braking force is insufficient for the required braking force, by controlling the solenoid-in valve 19 by the proportional control, as shown in FIG. 11, the wheel cylinder pressure can be increased using the high pressure brake fluid stored in the fluid suction part 15. Therefore, it is possible to increase the friction braking force in response to the further depression of the brake pedal BP, and the required braking force can be secured (a time period from time t1 to time t2 in FIG. 12).

(e) Regenerative Brake Cooperative Control from the Beginning of the Braking (the Regenerative Braking Force is Produced from the Beginning of the Braking) (the Required Braking Force>the Maximum Regenerative Braking Force)

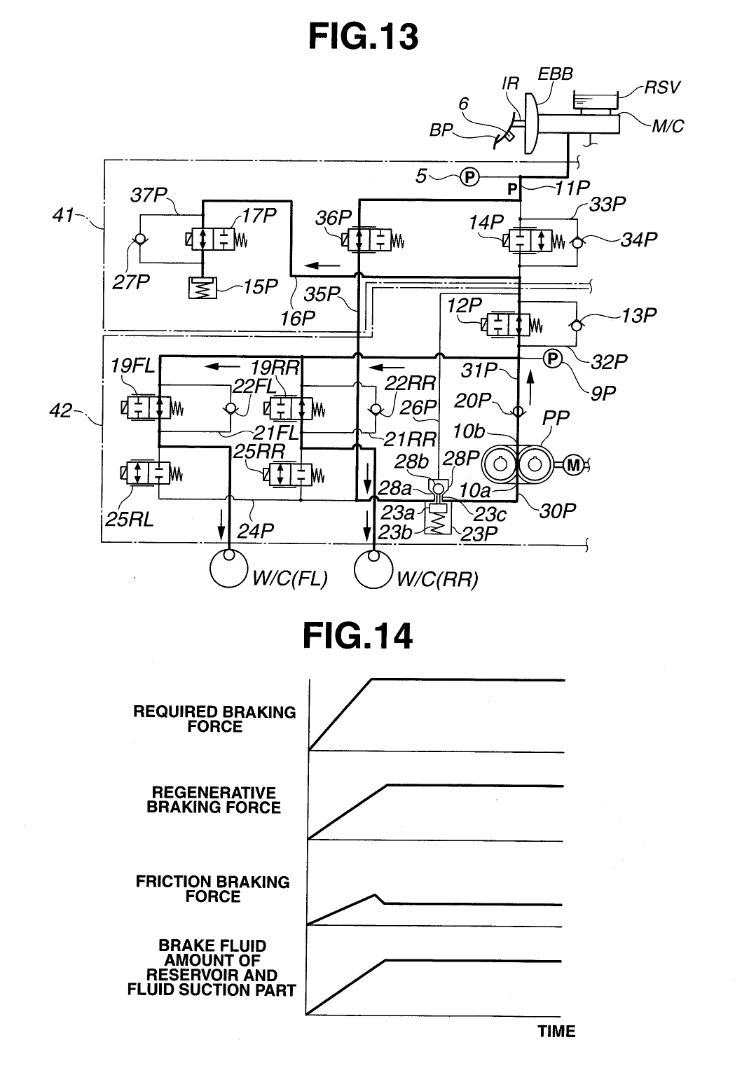

In a case where the intervention of the regenerative brake cooperative control is made from the beginning of the braking and the required braking force can not be obtained by only the regenerative braking force, the cut-off valve 14 is closed, the fluid suction part opening/closing valve 17 and the stroke simulator valve 36 are opened, the proportional control of the solenoid-in valve 19 is performed and the pump P is operated from the normal braking state. The solenoid-in valve 19 is controlled by the proportional control so as to generate the friction braking force that covers or compensates for the shortage in the regenerative braking force. With this operation, as shown in FIG. 13, some brake fluid required to compensate for the shortage in the regenerative braking force of the brake fluid flowing out from the master cylinder M/C can be supplied to the wheel cylinder W/C, and the rest of the brake fluid can be stored in the fluid suction part 15. Thus the shortage in the regenerative braking force for the required braking force can be compensated by the friction braking force (FIG. 14).

[Intervention of Abs Control During Execution of Regenerative Brake Cooperative Control]

An excess brake fluid that flows out to the reservoir 23 by a braking force decrease command (a pressure decrease command) of the ABS control is pumped up by the pump P and is kept stored in the fluid suction part 15. Then by using this brake fluid at next pressure increase command, an amount of the brake fluid that returns to an upstream side (the master cylinder M/C side) at a time of the pressure decrease is suppressed, thereby reducing a pedal kickback.

(f) Intervention of the ABS Control (in a Case where Only the Regenerative Braking Force is Decreased)

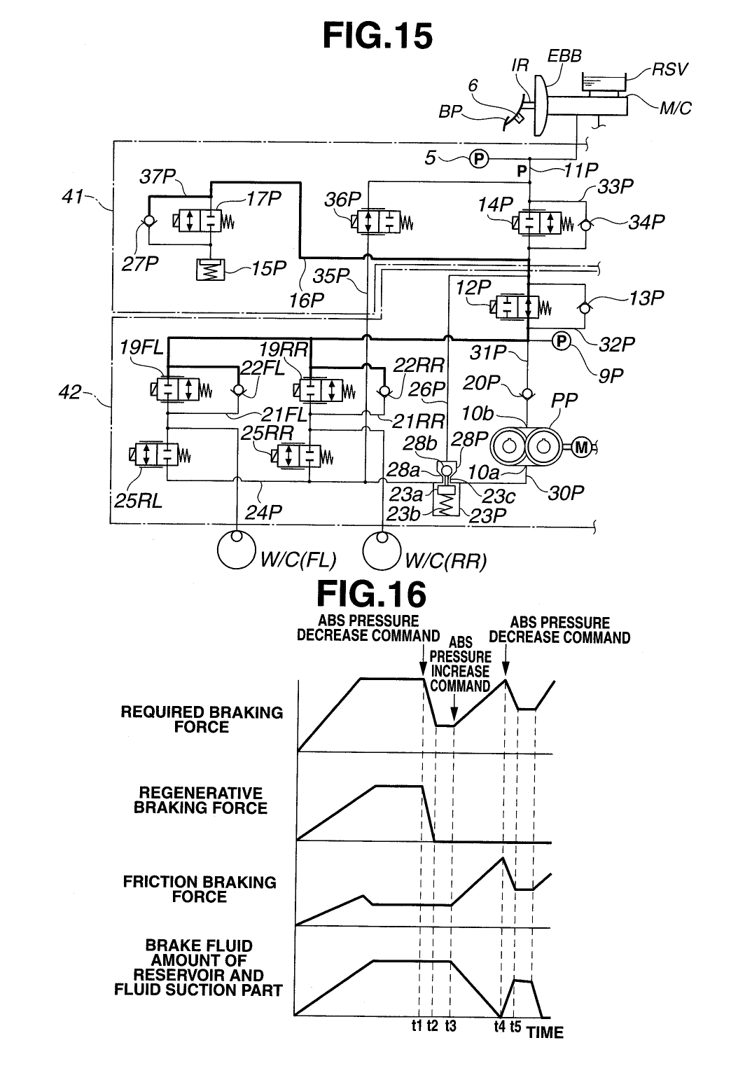

In a case where the pressure decrease command by the intervention of the ABS control is issued, when this pressure decrease can be achieved by only the decrease of the regenerative braking force for the pressure decrease command, the stroke simulator valve 36 is closed by the proportional control, and the solenoid-in valve 19 and the fluid suction part opening/closing valve 17 are closed from the state of (e). With this operation, as shown in FIG. 15, the flowing-out of the brake fluid from the master cylinder M/C to the hydraulic pressure control unit HU and the increase/decrease of the wheel cylinder pressure can be restrained. Thus, when the pressure decrease command by the ABS control intervention is issued, it is possible to realize the decrease of the braking force by only the decrease of the regenerative braking force (a time period from time t1 to time t2 in FIG. 16). At this time, the fluid suction part 15 and the pipes between the fluid suction part 15 and the solenoid-in valve 19 are maintained at the high pressure state.

(g) Pressure Increase after the Abs Pressure Decrease

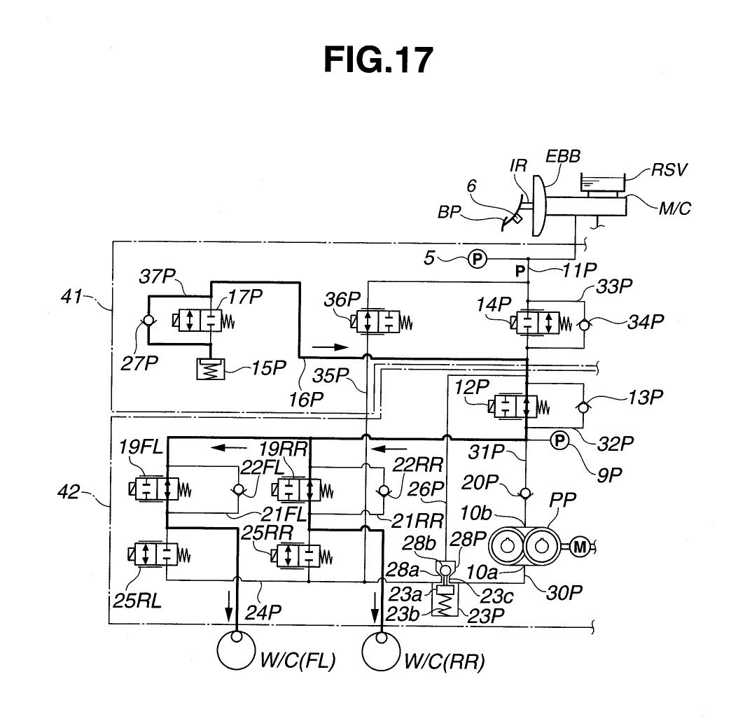

As shown by a time period from time t3 to time t4 in FIG. 16, in a case where the pressure increase command is issued after the pressure decrease command of the ABS control, the solenoid-in valve 19 is opened by the proportional control in accordance with the pressure increase command. With this operation, as shown in FIG. 17, a part of the high pressure brake fluid stored in the fluid suction part 15 is supplied to the wheel cylinder W/C from the pipe 37 bypassing the fluid suction part opening/closing valve 17 through the pipes 11 and 18, then the wheel cylinder pressure can be increased.

Here, in the related art brake control apparatus, when the pressure decrease of the ABS control is set, the brake fluid flowing out from the wheel cylinder is stored in the reservoir, then when the command shifts to the pressure increase command, the brake fluid stored in the reservoir is pumped up by the pump and the wheel cylinder is increased. At this time, the increase of the wheel cylinder depends on a capacity of the pump. Thus there might occur a delay in the pressure increase until the wheel cylinder pressure is actually increased or rises up in response to the pressure increase command.

In contrast to this, in this control, upon the pressure increase of the ABS control, the high pressure brake fluid stored in the fluid suction part 15 can be supplied to the wheel cylinder W/C. Hence, it is possible to immediately increase the pressure of the wheel cylinder W/C independently of the pump capacity.

(h) Re-Pressure Decrease of the ABS Control

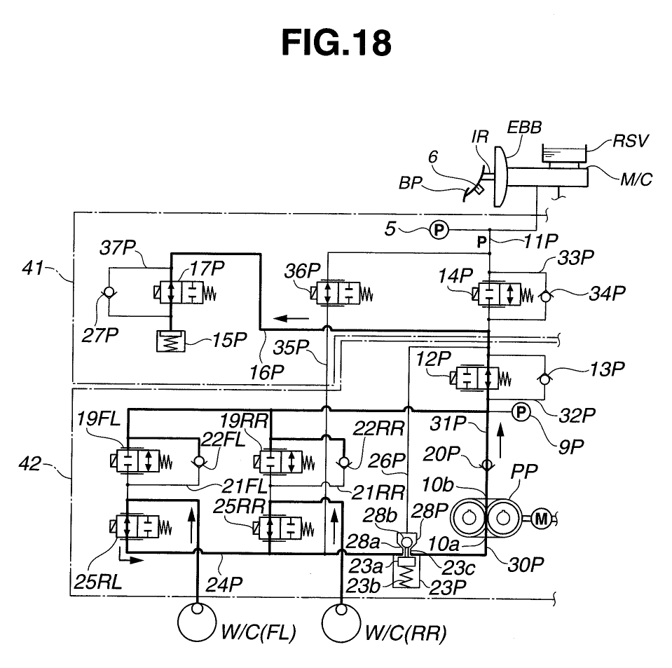

As shown by a time period from time t4 to time t5 in FIG. 16, when the pressure decrease command of the ABS control is issued again, the solenoid-in valve 19 is closed by the proportional control, and the solenoid-out valve 25 and the fluid suction part opening/closing valve 17 are opened. With this operation, as shown in FIG. 18, the wheel cylinder W/C pressure can be decreased, and the brake fluid flowing out from the wheel cylinder W/C to the reservoir 23 is stored in the fluid suction part 15 without returning to the master cylinder M/C side.

Here, in a case where the electric booster EBB is used as the booster, response of an actuator with respect to the return of the brake fluid is low as compared with a negative pressure booster. Because of this, if the high pressure brake fluid is returned to the master cylinder M/C from the wheel cylinder W/C at the pressure decrease command of the ABS control, there is a risk that the master cylinder will be damaged. For this problem, the operation is performed so as not to return the brake fluid to the master cylinder M/C, thereby protecting the master cylinder M/C.

(i) Intervention of the Abs Control (in a Case where the Friction Braking Force is Decreased)

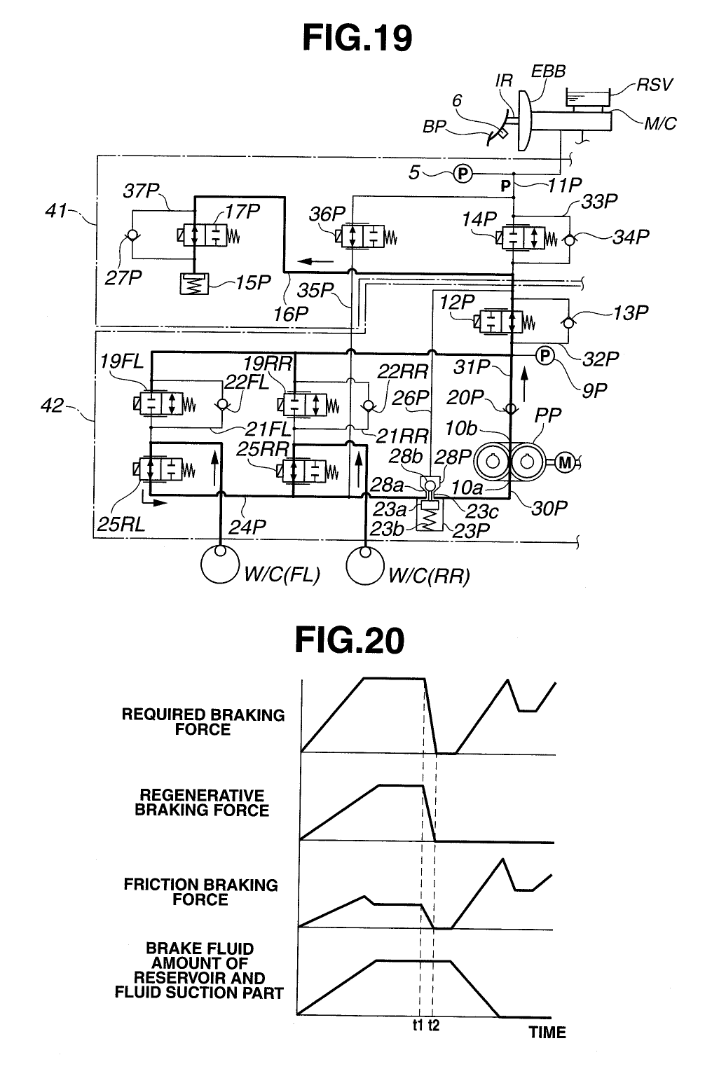

In a case where the pressure decrease command by the intervention of the ABS control is issued during the execution of the regenerative brake cooperative control, when the pressure decrease by only the decrease of the regenerative braking force is insufficient (namely that the pressure decrease can not be achieved by only the decrease of the regenerative braking force) and it is required to decrease the friction braking force, the stroke simulator valve 36 and the solenoid-in valve 19 are closed by the proportional control, and the solenoid-out valve 25 is opened from the state of (e). With this operation, as shown in FIG. 19, the brake fluid flowing out from the wheel cylinder W/C can be stored in the fluid suction part 15 while restraining the flowing-out of the brake fluid from the master cylinder M/C to the wheel cylinder W/C. It is therefore possible to realize the pressure decrease of the wheel cylinder W/C, which is the demand of the ABS control, by the decrease of both the regenerative braking force and the friction braking force (a time period from time t1 to time t2 in FIG. 20).

[Intervention of Brake Assist Control During Execution of Regenerative Brake Cooperative Control]

The brake fluid is pumped up from the pipe 26 by the pump P, and regulation of the master cylinder pressure and the wheel cylinder pressure is carried out by the gate-out valve 12 (which correspond to a brake assist control section).

(j) In a Case where the Regenerative Braking Force does Not Lower

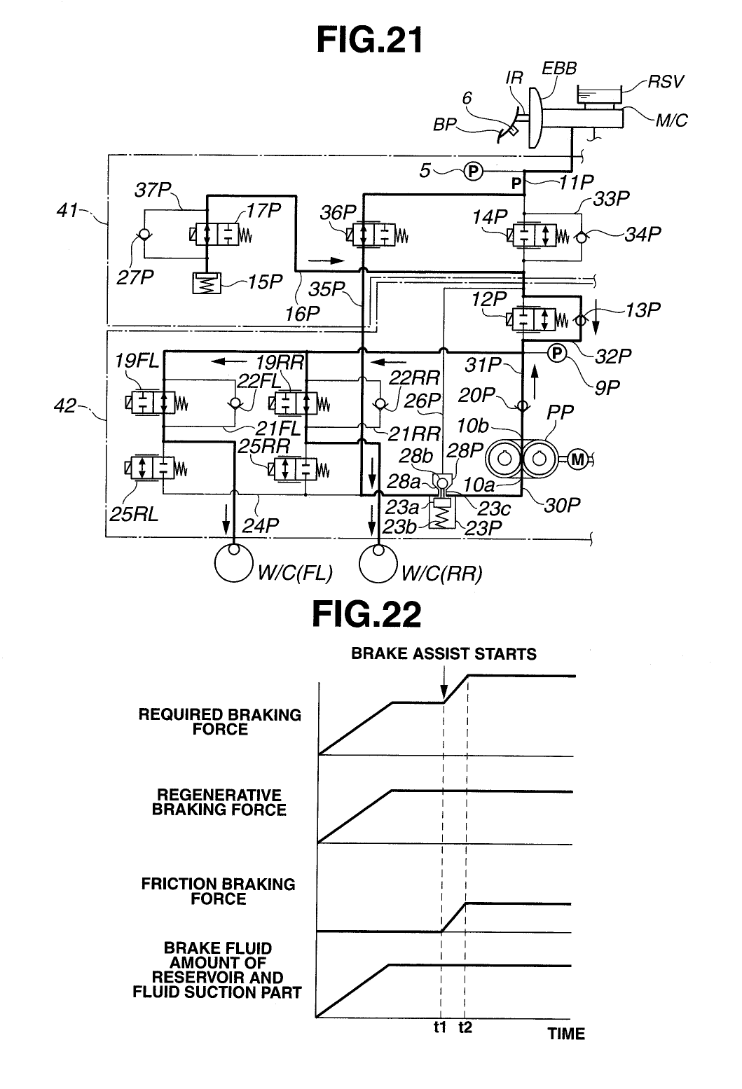

In a case where the intervention of the brake assist control is made during the execution of the regenerative brake cooperative control and the regenerative braking force does not lower, the gate-out valve 12 is closed by the proportional control, and the proportional control of the solenoid-in valve 19 is performed in accordance with a pressure increase command of the brake assist control from the state of (a). With this operation, as shown in FIG. 21, the brake fluid stored in the fluid suction part 15 is supplied to the wheel cylinder W/C. It is therefore possible to immediately increase the pressure of the wheel cylinder W/C using the high pressure brake fluid stored in the fluid suction part 15 (a time period from time t1 to time t2 in FIG. 22).

(k) In a Case where the Regenerative Braking Force Lowers

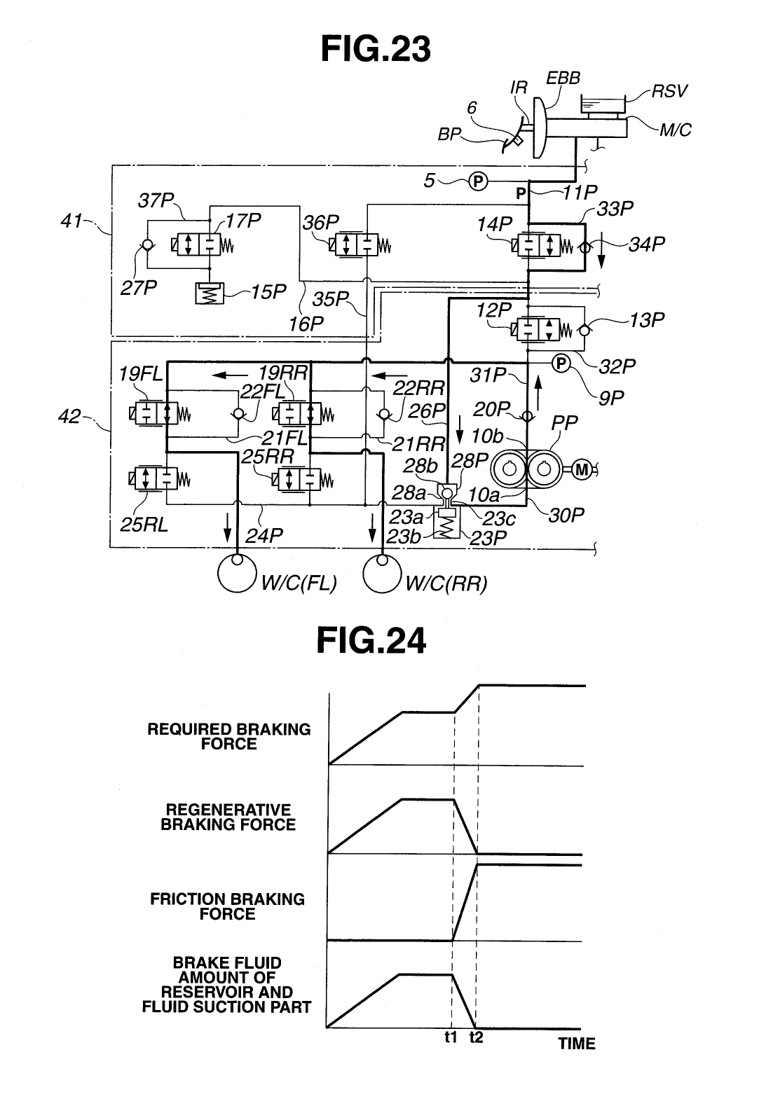

In a case where the intervention of the brake assist control is made during the execution of the regenerative brake cooperative control and the regenerative braking force lowers, when the brake fluid is stored in the fluid suction part 15, the same operation as (j) is performed. Subsequently, when the fluid suction part 15 is empty, the solenoid-in valve 19 is opened, and the stroke simulator valve 36 is closed. With this operation, as shown in FIG. 23, the brake fluid in the master cylinder M/C is pumped up through the pipe 33 bypassing the cut-off valve 14 by the pump P, thereby supplying the brake fluid to the wheel cylinder W/C (a time period from time t1 to time t2 in FIG. 24).

(l) Pressure Decrease During Execution of the Brake Assist Control

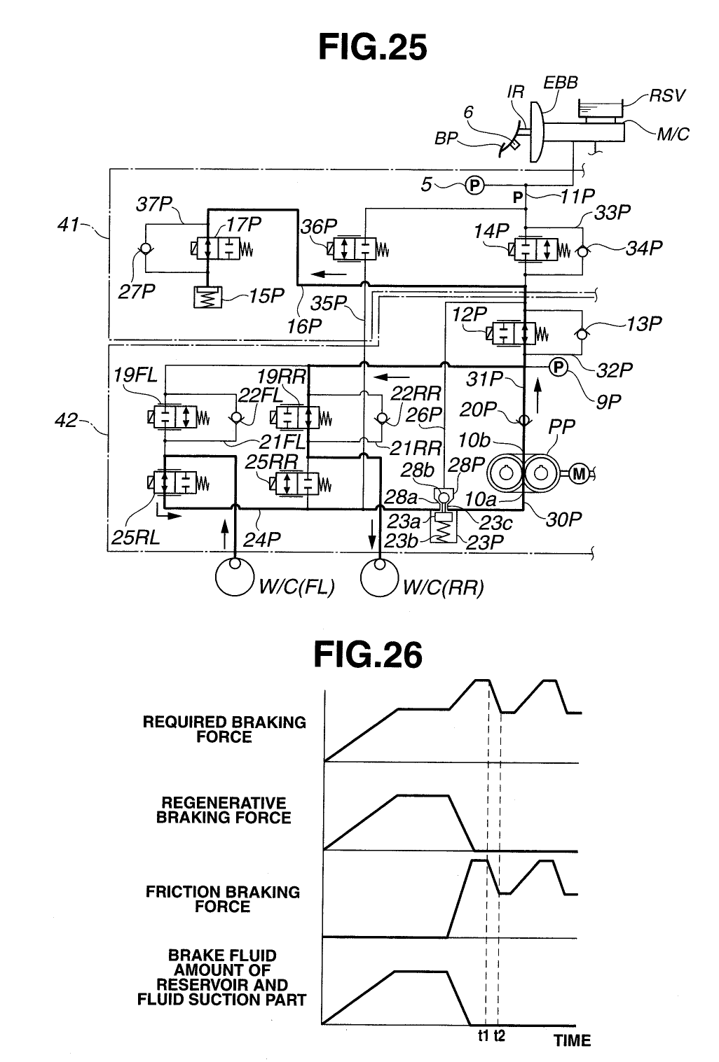

In a case where only the wheel cylinder pressure of a certain wheel is decreased by the intervention etc. of the ABS control during the execution of the brake assist control, the solenoid-in valve 19 of the certain wheel (e.g. the front left wheel FL) targeted for the control of the pressure decrease is closed, the solenoid-out valve 25 is opened, and the fluid suction part opening/closing valve 17 is opened. Further, the proportional control of the gate-out valve 12 is performed. By opening the solenoid-in valve 19 of non-target wheel for the control and performing the proportional control of the gate-out valve 12, the wheel cylinder pressure is regulated. With this, as shown in FIG. 25, the brake fluid flows out to the reservoir 23 through the solenoid-out valve 25 which corresponds to the front left wheel FL, then the wheel cylinder pressure can be decreased (a time period from time t1 to time t2 in FIG. 26). That is, it is possible to decrease only the wheel cylinder pressure of the certain wheel during the execution of the brake assist control. Here, since the detection value of the first pressure sensor 5 is smaller than the detection value of the second pressure sensor 9 (the detection value of the first pressure sensor 5<the detection value of the second pressure sensor 9) during the brake assist control, an excess brake fluid which flows out to the reservoir 23 by the pressure decrease and is pumped up by the pump P is stored in the fluid suction part 15.

[Intervention of Vehicle Behavior Stabilization Control During Execution of Regenerative Brake Cooperative Control]

(m) In a Case where the Brake Fluid Stored in the Fluid Suction Part 15 is Sufficient for the Increase of the Friction Braking Force

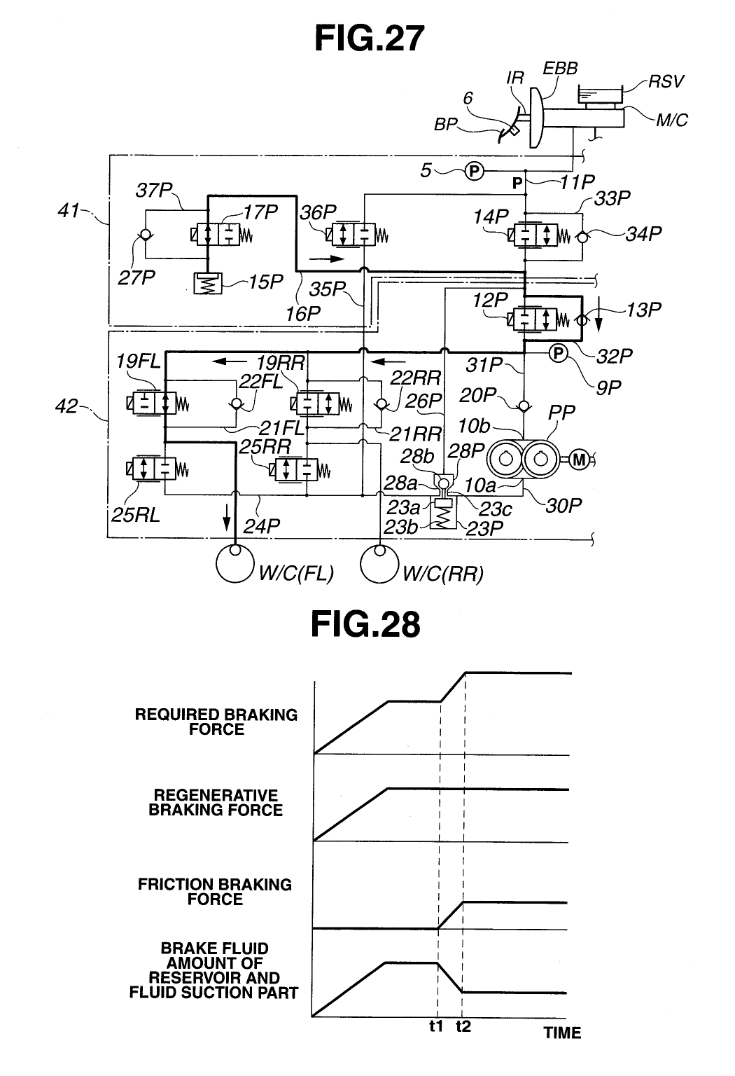

In a case where the intervention of the vehicle behavior stabilization control is made during the execution of the regenerative brake cooperative control and the brake fluid stored in the fluid suction part 15 is sufficient for the increase of the friction braking force, the solenoid-in valve 19 of a certain wheel targeted for the control of the pressure increase is controlled by the proportional control in accordance with a pressure increase command of the vehicle behavior stabilization control, and the gate-out valve 12 is closed by the proportional control. On the other hand, the solenoid-in valve 19 of non-target wheel for the control is closed, and the wheel cylinder pressure is maintained. With this, as shown in FIG. 27, the brake fluid stored in the fluid suction part 15 can be supplied to the wheel cylinder W/C, and it is possible to immediately increase the wheel cylinder pressure of the certain wheel targeted for the control using the high pressure brake fluid stored in the fluid suction part 15 (a time period from time t1 to time t2 in FIG. 28).

(n) In a Case where the Brake Fluid Stored in the Fluid Suction Part 15 is Insufficient for the Increase of the Friction Braking Force

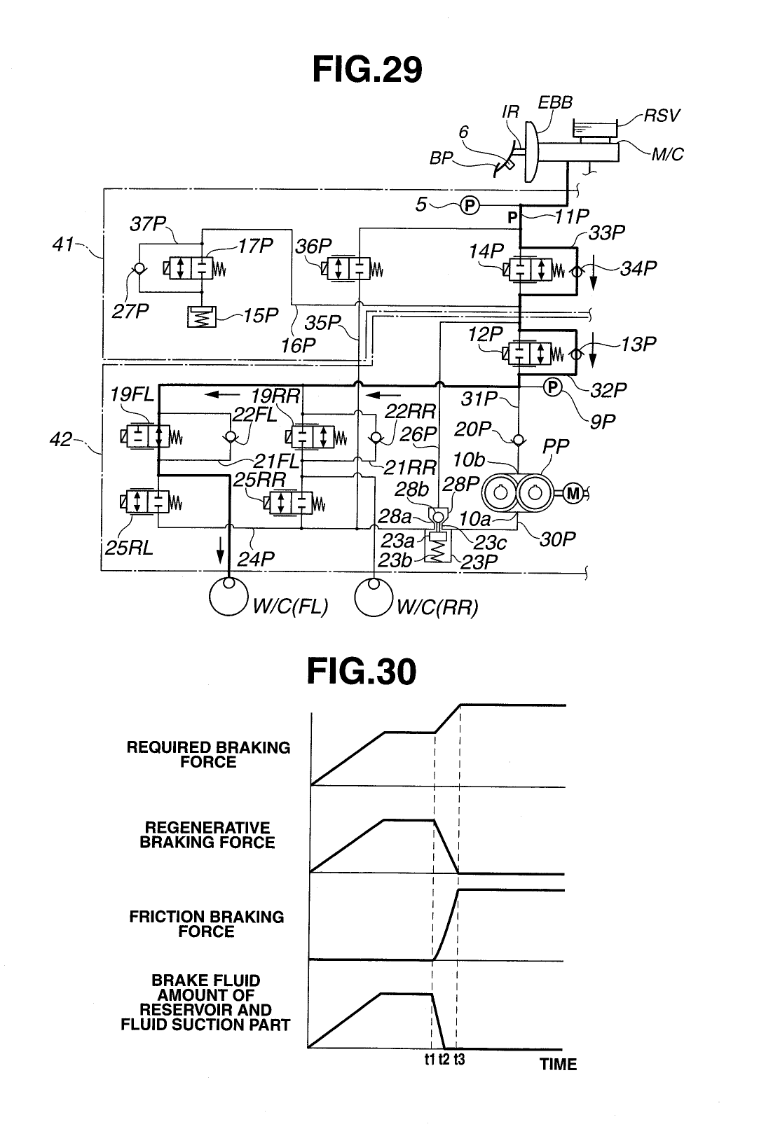

In a case where the intervention of the vehicle behavior stabilization control is made during the execution of the regenerative brake cooperative control and the brake fluid stored in the fluid suction part 15 is insufficient for the increase of the friction braking force, when the brake fluid is stored in the fluid suction part 15, the same operation as (m) is performed (a time period from time t1 to time t2 in FIG. 30). Subsequently, when the fluid suction part 15 is empty, the fluid suction part opening/closing valve 17 is closed, and the gate-out valve 12 is closed by the proportional control. With this operation, as shown in FIG. 29, it is possible to increase the wheel cylinder pressure of the certain wheel targeted for the control by the brake fluid flowing into the hydraulic pressure control unit HU from the master cylinder M/C (a time period from time t2 to time t3 in FIG. 30).

[Operation Logic of Cut-Off Valve, Fluid Suction Part Opening/Closing Valve and Gate-Out Valve]

In the above description, although the operation of each valve and the pump P in the hydraulic pressure control unit HU has been explained for each scene, the operations of the cut-off valve 14, the fluid suction part opening/closing valve 17 and the gate-out valve 12 are determined from a relationship between the fluid pressure (a sensor 1) detected by the first pressure sensor 5, the fluid pressure (a sensor 2) detected by the second pressure sensor 9 and a spring reaction force of the fluid suction part 15.

sensor 1=sensor 2<spring reaction force (a)

In this case, since the normal braking is in progress, all of the cut-off valve 14, the fluid suction part opening/closing valve 17 and the gate-out valve 12 are not operated (i.e. non-power application state).

spring reaction force<sensor 1=sensor 2 (b)

In this case, since the normal braking is in progress, all of the cut-off valve 14, the fluid suction part opening/closing valve 17 and the gate-out valve 12 are not operated (i.e. non-power application state).

spring reaction force<sensor 1<sensor 2 (c)

When the sensor 1 is greater than the spring reaction force and also the sensor 2 is greater than the spring reaction force, since this is a case where the wheel cylinder pressure is increased by the pump-up in a state in which the brake pedal BP is depressed, the cut-off valve 14 and the fluid suction part opening/closing valve 17 are not operated, and the gate-out valve 12 is operated.

sensor 1<spring reaction force<sensor 2 (d)

When the spring reaction force is greater than the sensor 1 and also the sensor 2 is greater than the spring reaction force, since this is a case where the wheel cylinder pressure is increased by the pump-up in a state in which the brake pedal BP is not depressed, all of the cut-off valve 14, the fluid suction part opening/closing valve 17 and the gate-out valve 12 are operated.

sensor 1<spring reaction force=sensor 2 (e)

When the spring reaction force is greater than the sensor 1 and also the spring reaction force is the same value as the sensor 2, since this is a case where the wheel cylinder pressure is increased by the fluid suction part 15, the cut-off valve 14 and the fluid suction part opening/closing valve 17 are operated, and the gate-out valve 12 is not operated.

Here, in the brake circuit, since the pipe 33 is provided parallel to the cut-off valve 14 and the check valve 34 allowing only the flow of the brake fluid from the master cylinder M/C is provided on the pipe 33, a relationship of sensor 1>sensor 2 is not established.

[State Judgment Method of Fluid Suction Part]

In the hydraulic pressure control unit HU of the embodiment 1, when the brake pedal BP is not depressed, by opening the stroke simulator valve 36 and the fluid suction part opening/closing valve 17, closing the cut-off valve 14 and the solenoid-in valve 19 and operating the pump P for a certain time, a judgment about whether the fluid suction part 15 functions normally or not is made. Since the pressure of the brake fluid stored in the fluid suction part 15 can be estimated from a rotation speed and an operating time of the motor M that drives the pump P, this estimated value and the brake fluid pressure detected by the second pressure sensor 9 are compared. Then when these two values are different, it is possible to judge that the fluid suction part 15 does not function normally, namely that it is possible to detect an occurrence of failure of the fluid suction part 15.

[Influence in Improvement in Pedal Feel]

In the brake control apparatus in JP2002-255018, the stroke simulator is provided in a brake circuit, and during the automatic braking or the regenerative brake cooperative control, the brake fluid flowing out from the master cylinder is sucked or absorbed into the stroke simulator, thereby generating pedal feel.

However, in the related art brake control apparatus of JP2002-255018, in a case where the further depression of the brake pedal is done by the driver in a state in which the brake fluid is stored in the stroke simulator, when the master cylinder pressure is higher than the pressure of the brake fluid stored in the stroke simulator, the brake fluid can not be discharged from the stroke simulator. Because of this, it is impossible to supply the brake fluid according to the brake pedal stroke amount to the wheel cylinder, and the deceleration in response to the brake pedal stroke amount becomes low, and this causes deterioration in the pedal feel.

In contrast to this, in the brake control apparatus of the embodiment 1, upon the regenerative brake cooperative control, the cut-off valve 14 is closed, and the brake fluid flowing out from the master cylinder M/C is released to the reservoir 23 while performing the proportional control of the stroke simulator valve 36, thereby generating the brake pedal characteristic of the normal braking and realizing the good pedal feel.

[Influence in Improvement in Pressure Increase Response]

By storing (or keeping) the brake fluid flowing out to the reservoir 23 in the fluid suction part 15 by the operation of the pump P during the regenerative brake cooperative control, the wheel cylinder pressure can be increased immediately using the high pressure brake fluid stored in the fluid suction part 15, when the further depression of the brake pedal BP is done by the driver during the execution of the regenerative brake cooperative control, and when the brake shift from the regenerative braking force to the friction braking force is executed, and when the pressure increase demand of the wheel cylinder pressure by the intervention of the ABS control or the intervention of the brake assist control is issued during the execution of the regenerative brake cooperative control.

Here, during the normal braking, since the fluid suction part opening/closing valve 17 is closed, the brake fluid flowing out from the master cylinder M/C is stored in the fluid suction part 15, thereby preventing the deterioration in the pedal feel.

In the brake control apparatus of the embodiment 1, the pipe 33 is provided parallel to the cut-off valve 14 and the check valve 34 allowing only the flow of the brake fluid from the master cylinder M/C is provided on the pipe 33. Thus, when the pressure increase demand of the wheel cylinder pressure by the intervention of the brake assist control or the intervention of the vehicle behavior stabilization control is issued during the execution of the regenerative brake cooperative control and also the fluid suction part 15 is empty, the brake fluid in the master cylinder M/C is pumped up through the pipe 33 by the pump P, thereby increasing the wheel cylinder pressure.

[Influence in Cost Reduction]

In the brake control apparatus of the embodiment 1, the hydraulic pressure control unit HU is formed by the first unit 39 and the second unit 40. The first unit 39 has the cut-off valve 14, the fluid suction part 15, the fluid suction part opening/closing valve 17 and the stroke simulator valve 36 in the first housing 41. The second unit 40 has the gate-out valve 12, the pump P, the solenoid-in valve 19 and the solenoid-out valve 25 in the second housing 42. Here, the second unit 40 is the same as an existing hydraulic pressure control unit in the hydraulic configuration. Hence, only by adding the first unit 39 to the existing hydraulic pressure control unit, the hydraulic pressure control unit HU that can realize the regenerative brake cooperative control can be obtained, and this contributes to the cost reduction.

Next, effects will be explained. The brake control apparatus of the embodiment 1 has the following effects.

(1) The brake control apparatus used for the vehicle having the regenerative braking system (the motor/generator MG, the inverter INV, the battery BATT and the motor control unit MCU), has: the pump P provided in the brake circuit; the first brake circuit 11, 18 connecting the master cylinder M/C that generates the brake fluid pressure by driver's brake operation and the wheel cylinder W/C that is configured so that the brake fluid pressure acts on; the second brake circuit 31 connecting the first brake circuit 11, 18 and the outlet side (the outlet section 10b) of the pump P; the gate-out valve 12 provided at the master cylinder M/C side with respect to the connection point of the second brake circuit 31, on the first brake circuit 11, 18; the third brake circuit 26 connecting the point positioned at the master cylinder M/C side with respect to the gate-out valve 12 and the inlet side (the inlet section 10a) of the pump P, on the first brake circuit 11, 18; the inflow valve (the solenoid-in valve) 19 provided at the wheel cylinder W/C side with respect to the connection point of the second brake circuit 31, on the first brake circuit 11, 18; the fourth brake circuit 24, 30 connecting the point positioned at the wheel cylinder W/C side with respect to the solenoid-in valve 19 and the inlet side 10a of the pump P, on the first brake circuit 11, 18; the outflow valve (the solenoid-out valve) 25 provided on the fourth brake circuit 24, 30; the reservoir 23 provided, on the fourth brake circuit 24, 30, at the inlet side 10a of the pump P with respect to the solenoid-out valve 25 and connecting to the third brake circuit 26; the fluid suction part 15 into which the brake fluid can flow; the cut-off valve 14 provided between the master cylinder M/C and the gate-out valve 12 on the first brake circuit 11, 18; the check valve 34 arranged parallel to the cut-off valve 14 and allowing only a flow of the brake fluid in a direction from the master cylinder M/C to the wheel cylinder W/C; the branch oil passage (the pipe) 16 branching off from the point between the cut-off valve 14 and the gate-out valve 12 and connecting to the fluid suction part 15; the fifth brake circuit 35 branching off from the point between the master cylinder M/C and the cut-off valve 14 on the first brake circuit 11, 18 and connecting to the reservoir 23; the stroke simulator valve 36 provided on the fifth brake circuit 35 and regulating the amount of the brake fluid that flows into the reservoir 23 from the master cylinder M/C; and the hydraulic pressure control unit (the brake control unit) BCU controlling the brake fluid pressure by operating the each valve and the pump P in accordance with the regenerative operation state of the regenerative braking system.

With this, it is possible to improve the pedal feel upon the execution of the regenerative brake cooperative control.

(2) The brake control apparatus further has: the fluid suction part opening/closing valve 17 on the branch oil passage 16. Therefore, upon the execution of the regenerative brake cooperative control or the ABS control, it is possible to store or keep the brake fluid, which flows out from the wheel cylinder W/C to decrease the wheel cylinder pressure, in the fluid suction part 15. In addition, during the normal braking, since the fluid suction part opening/closing valve 17 is closed, the fluid suction part 15 is intercepted or isolated from the first brake circuit 11, 18, and the brake fluid flowing out from the master cylinder M/C is stored in the fluid suction part 15. It is therefore possible to prevent the brake pedal characteristic from changing.

(3) The brake control apparatus further has the first pressure sensor 5 that detects the brake fluid pressure at the point on the first brake circuit 11, 18 which is positioned at the master cylinder M/C side with respect to the connection point of the first brake circuit 11, 18 with the fifth brake circuit 35, and the second pressure sensor 9 that detects the discharge pressure of the pump P. By operating each valve so that the brake fluid pressure detected by the first pressure sensor 5 matches or agrees with the target master cylinder pressure and operating the pump P so that the brake fluid pressure detected by the second pressure sensor 9 matches or agrees with the target master cylinder pressure, improvement in brake feel and controllability during the execution of the regenerative brake cooperative control and the automatic brake control can be realized.

(4) The brake control apparatus further has the brake operation state detection section (the brake pedal stroke sensor) 6 that detects driver's brake operation state (the brake pedal stroke amount or the brake operation amount). The brake control unit BCU has the brake assist control section that when the increase in the brake operation amount is detected by the brake pedal stroke sensor 6 and the pressure detected by the first pressure sensor 5 is smaller than the pressure detected by the second pressure sensor 9, increases the wheel cylinder pressure by the brake fluid in the fluid suction part 15. With this, it is possible to immediately increase the pressure of the wheel cylinder W/C using the high pressure brake fluid stored in the fluid suction part 15.

(5) The brake control apparatus further has the brake operation state detection section (the brake pedal stroke sensor) 6 that detects driver's brake operation state (the brake pedal stroke amount or the brake operation amount). The brake control unit BCU has the brake assist control section that when the increase in the brake operation amount is detected by the brake pedal stroke sensor 6 and the regenerative braking force by the regenerative braking system lowers also the pressure detected by the first pressure sensor 5 is greater than or equal to the pressure detected by the second pressure sensor 9, increases the wheel cylinder pressure by the brake fluid in the master cylinder M/C and the brake fluid in the fluid suction part 15 through the first brake circuit 11, 18, the check valve 34 and the third brake circuit 26 by operating the stroke simulator valve 36 in the valve closing direction, operating the gate-out valve 12 in the valve closing direction and operating the pump P.

With this, in the case where the brake fluid is not stored in the fluid suction part 15, the wheel cylinder pressure can be increased by the brake fluid sucked from the master cylinder M/C.

### Other Embodiments

The embodiment of the present invention has been explained above on the basis of the embodiment 1. However, the configuration or system of the present invention is not limited to the embodiment 1.

For instance, in the embodiment 1, the electric booster is used. However, the negative pressure booster can be employed.

The above embodiments can produce advantageous effects as described above. In addition to that, modified examples having substantially the same effects as the above embodiments will be explained below.

(a) In the brake control apparatus, when the pressure decrease of the wheel cylinder pressure is required during execution of the brake assist control by the brake assist control section, the hydraulic pressure control unit BCU delivers the brake fluid in the wheel cylinder W/C to the fluid suction part 15 by operating the inflow valve 19 in the valve closing direction, operating the outflow valve 25 in the valve opening direction and operating the pump P.

It is therefore possible to decrease only the wheel cylinder pressure of the certain wheel during the execution of the brake assist control.

(b) The brake control apparatus further has the brake operation state detection section 6 that detects driver's brake operation state. When the brake operation is detected by the brake operation state detection section 6 and the regenerative braking system works, the hydraulic pressure control unit BCU sucks up the brake fluid through the stroke simulator valve 36 and the fifth brake circuit 35 by operating the cut-off valve 14 and the inflow valve 19 in the valve closing direction and operating the pump P, and pours the brake fluid flowing out from the master cylinder M/C into the fluid suction part 15 through the gate-out valve 12.

Thus, since the brake fluid flowing out from the master cylinder M/C according to the driver's brake operation can be stored in the fluid suction part 15, the generation of the friction braking force can be prevented, and the driver's required braking force is produced by only the regenerative braking force. The energy recovery efficiency can therefore be increased. Further, it is possible to improve the pedal feel upon the execution of the regenerative brake cooperative control.

(c) In the brake control apparatus, when the regenerative braking amount of the regenerative braking system lowers, the hydraulic pressure control unit BCU operates the stroke simulator valve 36 in the valve closing direction and operates the inflow valve 19 in the valve opening direction according to the lowering of the regenerative braking amount, and supplies the brake fluid in the fluid suction part 15 to the wheel cylinder W/C.

Thus, the required braking force can be secured by the brake shift from the regenerative braking force to the friction braking force. Further, it is possible to immediately increase the friction braking force using the high pressure brake fluid stored in the fluid suction part 15.

(d) In the brake control apparatus, when the regenerative braking system works while the brake fluid pressure generated by the driver's brake operation acts on the wheel cylinder W/C, the hydraulic pressure control unit BCU operates the inflow valve 19 in the valve closing direction, operates the gate-out valve 12, the outflow valve 25 and the fluid suction part opening/closing valve 17 in the valve opening direction and operates the pump P. Thus, the required braking force can be secured by the brake shift from the friction braking force to the regenerative braking force.

(e) The brake control apparatus further has the brake operation state detection section 6 that detects driver's brake operation state. When the increase in driver's brake operation amount is detected by the brake operation state detection section 6 while the regenerative braking system works, the hydraulic pressure control unit BCU operates the inflow valve 19 in the valve opening direction and increases the wheel cylinder pressure by the brake fluid in the fluid suction part 15.

Thus, in the case where the regenerative braking force is insufficient for the required braking force, by increasing the wheel cylinder pressure using the high pressure brake fluid stored in the fluid suction part 15, the required braking force can be secured.

(f) The brake control apparatus further has the anti-lock brake control section that increase/decreases the braking force to suppress the lock state of the wheel. When the regenerative braking force is decreased by the braking force decrease command by the anti-lock brake control section while the brake fluid pressure acts on the wheel cylinder W/C, the hydraulic pressure control unit BCU operates the inflow valve 19 and the outflow valve 25 in the valve closing direction and brings the wheel cylinder pressure in the holding state.

The decrease of the braking force by the braking force decrease command can therefore be achieved by only the decrease of the regenerative braking force.

(g) In the brake control apparatus, the hydraulic pressure control unit BCU operates the inflow valve 19 in the valve opening direction in response to the braking force increase command after the braking force decrease command by the anti-lock brake control section, and increases the wheel cylinder pressure by the brake fluid in the fluid suction part 15.

It is therefore possible to immediately increase the pressure of the wheel cylinder W/C using the high pressure brake fluid stored in the fluid suction part 15, and the pressure increase response can be improved.

(h) In the brake control apparatus, the hydraulic pressure control unit BCU operates the outflow valve 25 in the valve opening direction and operates the pump P in response to the braking force decrease command after the braking force increase command by the anti-lock brake control section, and delivers the brake fluid in the wheel cylinder W/C to the fluid suction part 15.

Hence, the brake fluid flowing out from the wheel cylinder W/C to the reservoir 23 does not return to the master cylinder M/C, thereby protecting the master cylinder M/C.

(i) The brake control apparatus further has the anti-lock brake control section that increase/decreases the braking force to suppress the lock state of the wheel. The hydraulic pressure control unit BCU operates the inflow valve 19 in the valve closing direction, operates the outflow valve 25 in the valve opening direction and operates the pump P in response to the braking force decrease command by the anti-lock brake control section when the brake fluid pressure acts on the wheel cylinder W/C, and delivers the brake fluid in the wheel cylinder W/C to the fluid suction part 15.

The decrease of the braking force by the braking force decrease command can therefore be achieved by the decrease of the regenerative braking force and the decrease of the friction braking force.

(j) The brake control apparatus further has the vehicle behavior stabilization control section that detects the vehicle behavior and ensures stabilization of the vehicle behavior by independently controlling the braking force of the certain wheel when detecting the predetermined behavior. When detecting the predetermined behavior during the brake operation by the regenerative braking of the regenerative braking system and the braking of the hydraulic pressure control unit BCU, the vehicle behavior stabilization control section increases the wheel cylinder pressure of the certain wheel by the brake fluid in the fluid suction part 15 to increase the braking force of the certain wheel.

Hence, control response of the vehicle behavior stabilization control can be improved.

(k) The brake control apparatus used for the vehicle having the regenerative braking system, has: the pump P provided in the brake circuit; the first brake circuit 11, 18 connecting the master cylinder M/C that generates the brake fluid pressure by driver's brake operation and the wheel cylinder W/C that is configured so that the brake fluid pressure acts on; the second brake circuit 31 connecting the first brake circuit 11, 18 and the outlet side 10b of the pump P; the gate-out valve 12 provided at the master cylinder M/C side with respect to the connection point of the second brake circuit 31, on the first brake circuit 11, 18; the third brake circuit 26 connecting the point positioned at the master cylinder M/C side with respect to the gate-out valve 12 and the inlet side 10a of the pump P, on the first brake circuit 11, 18; the inflow valve 19 provided at the wheel cylinder W/C side with respect to the connection point of the second brake circuit 31, on the first brake circuit 11, 18; the fourth brake circuit 24, 30 connecting the point positioned at the wheel cylinder W/C side with respect to the inflow valve 19 and the inlet side 10a of the pump P, on the first brake circuit 11, 18; the outflow valve 25 provided on the fourth brake circuit 24, 30; the reservoir 23 provided, on the fourth brake circuit 24, 30, at the inlet side 10a of the pump P with respect to the outflow valve 25 and connecting to the third brake circuit 26; the accumulator 15 into which the brake fluid can flow; the cut-off valve 14 provided between the master cylinder M/C and the gate-out valve 12 on the first brake circuit 11, 18; the check valve 34 arranged parallel to the cut-off valve 14 and allowing only the flow of the brake fluid from the master cylinder M/C; the branch oil passage 16 branching off from the point between the cut-off valve 14 and the gate-out valve 12 and connecting to the accumulator 15; the fifth brake circuit 35 branching off from the point between the master cylinder M/C and the cut-off valve 14 on the first brake circuit 11, 18 and connecting to the reservoir 23; the stroke simulator valve 36 provided on the fifth brake circuit 35 and regulating the amount of the brake fluid that flows into the reservoir 23 from the master cylinder M/C; the fluid suction part opening/closing valve 17 provided on the branch oil passage 16; and the hydraulic pressure control unit BCU controlling the brake fluid pressure by operating the each valve and the pump P in accordance with the regenerative operation state of the regenerative braking system, and when the regenerative braking system works, the brake fluid flowing out from the master cylinder M/C by the driver's brake operation is stored in the accumulator 15 by the pump operation of the pump P through the fifth brake circuit 35, the stroke simulator valve 36, the fluid suction part opening/closing valve 17, the reservoir 23, the second brake circuit 31, the gate-out valve 12, the first brake circuit 11, 18 and the branch oil passage 16. With this, it is possible to improve the pedal feel upon the execution of the regenerative brake cooperative control.

(l) The brake control apparatus further has the first pressure sensor 5 that detects the brake fluid pressure at the point on the first brake circuit 11, 18 which is positioned at the master cylinder M/C side with respect to the connection point of the first brake circuit 11, 18 with the fifth brake circuit 35; the second pressure sensor 9 that detects the discharge pressure of the pump P; and the brake operation state detection section 6 that detects driver's brake operation state. The hydraulic pressure control unit BCU has the brake assist control section that when the increase in the brake operation amount is detected by the brake operation state detection section 6 and the regenerative braking force by the regenerative braking system lowers also the pressure detected by the first pressure sensor 5 is greater than or equal to the pressure detected by the second pressure sensor 9, increases the wheel cylinder pressure by the brake fluid in the master cylinder M/C and the brake fluid in the accumulator 15 through the first brake circuit 11, 18, the check valve 34 and the third brake circuit 26 by operating the stroke simulator valve 36 in the valve closing direction, operating the gate-out valve 12 in the valve closing direction and operating the pump P.

With this, in the case where the brake fluid is not stored in the accumulator 15, the wheel cylinder pressure can be increased by the brake fluid sucked from the master cylinder M/C.

(m) The brake control apparatus used for the vehicle having the regenerative braking system, has: the pump P provided in the brake circuit; the first brake circuit 11, 18 connecting the master cylinder M/C that generates the brake fluid pressure by driver's brake operation and the wheel cylinder (W/C) that is configured so that the brake fluid pressure acts on; the second brake circuit 31 connecting the first brake circuit 11, 18 and the outlet side 10b of the pump P; the gate-out valve 12 provided at the master cylinder M/C side with respect to the connection point of the second brake circuit 31, on the first brake circuit 11, 18; the third brake circuit 26 connecting the point positioned at the master cylinder M/C side with respect to the gate-out valve 12 and the inlet side 10a of the pump P, on the first brake circuit 11, 18; the inflow valve 19 provided at the wheel cylinder W/C side with respect to the connection point of the second brake circuit 31, on the first brake circuit 11, 18; the fourth brake circuit 24, 30 connecting the point positioned at the wheel cylinder W/C side with respect to the inflow valve 19 and the inlet side 10a of the pump P, on the first brake circuit 11, 18; the outflow valve 25 provided on the fourth brake circuit 24, 30; the reservoir 23 provided, on the fourth brake circuit 24, 30, at the inlet side 10a of the pump P with respect to the outflow valve 25 and connecting to the third brake circuit 26; the fluid suction part 15 into which the brake fluid can flow; the cut-off valve 14 provided between the master cylinder M/C and the gate-out valve 12 on the first brake circuit 11, 18; the check valve 34 arranged parallel to the cut-off valve 14 and allowing only the flow of the brake fluid from the master cylinder M/C; the branch oil passage 16 branching off from the point between the cut-off valve 14 and the gate-out valve 12 and connecting to the fluid suction part 15; the fifth brake circuit 35 branching off from the point between the master cylinder M/C and the cut-off valve 14 on the first brake circuit 11, 18 and connecting to the reservoir 23; the stroke simulator valve 36 provided on the fifth brake circuit 35 and regulating the amount of the brake fluid that flows into the reservoir 23 from the master cylinder M/C; the fluid suction part opening/closing valve 17 provided on the branch oil passage 16; the first unit 39 having the first housing 41 that houses therein the cut-off valve 14, the fluid suction part 15, the fluid suction part opening/closing valve 17 and the stroke simulator valve 36; and the second unit 40 having the second housing 42 that houses therein the gate-out valve 12, the pump P, the inflow valve 19 and the outflow valve 25, and the first unit 39 and the second unit 40 are connected at the point between the stroke simulator valve 36 and the reservoir 23 on the fifth brake circuit 35 also at the point between the connection point of the first brake circuit 11, 18 with the third brake circuit 26 and the connection point of the first brake circuit 11, 18 with the branch oil passage 16 on the first brake circuit 11, 18.

Since the existing hydraulic pressure control unit can be used as the second unit 40, only by adding the first unit 39 to the existing hydraulic pressure control unit, the hydraulic pressure control unit HU that can realize the regenerative brake cooperative control can be obtained, and this contributes to the cost reduction.

(n) The brake control apparatus further has the hydraulic pressure control unit BCU that controls the brake fluid pressure by operating the each valve and the pump P in accordance with the regenerative operation state of the regenerative braking system.

It is therefore possible to realize the regenerative brake cooperative control according to the regenerative operation state of the regenerative braking system.

(o) The brake control apparatus further has the first pressure sensor 5 that detects the brake fluid pressure at the point on the first brake circuit 11, 18 which is positioned at the master cylinder M/C side with respect to the connection point of the first brake circuit 11, 18 with the fifth brake circuit 35; the second pressure sensor 9 that detects the discharge pressure of the pump P; and the brake operation state detection section 6 that detects driver's brake operation state. The hydraulic pressure control unit BCU has the brake assist control section that when the increase in the brake operation amount is detected by the brake operation state detection section 6 and the regenerative braking force by the regenerative braking system lowers also the pressure detected by the first pressure sensor 5 is greater than or equal to the pressure detected by the second pressure sensor 9, increases the wheel cylinder pressure by the brake fluid in the master cylinder M/C and the brake fluid in the fluid suction part 15 through the first brake circuit 11, 18, the check valve 34 and the third brake circuit 26 by operating the stroke simulator valve 36 in the valve closing direction, operating the gate-out valve 12 in the valve closing direction and operating the pump P.

With this, in the case where the brake fluid is not stored in the fluid suction part 15, the wheel cylinder pressure can be increased by the brake fluid sucked from the master cylinder M/C.

The entire contents of Japanese Patent Application No. 2010-288392 filed on Dec. 24, 2010 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus used for a vehicle having a regenerative braking system, comprising:
a pump provided in a brake circuit;
a first brake circuit connecting a master cylinder that generates a brake fluid pressure by driver's brake operation and a wheel cylinder that is configured so that the brake fluid pressure acts on;
a second brake circuit connecting the first brake circuit and an outlet side of the pump;
a gate-out valve provided at a master cylinder side with respect to a connection point of the second brake circuit, on the first brake circuit;
a third brake circuit connecting a point positioned at the master cylinder side with respect to the gate-out valve and an inlet side of the pump, on the first brake circuit;
an inflow valve provided at a wheel cylinder side with respect to the connection point of the second brake circuit, on the first brake circuit;
a fourth brake circuit connecting a point positioned at the wheel cylinder side with respect to the inflow valve and the inlet side of the pump, on the first brake circuit;
an outflow valve provided on the fourth brake circuit;
a reservoir provided, on the fourth brake circuit, at the inlet side of the pump with respect to the outflow valve and connecting to the third brake circuit;
a fluid suction part into which the brake fluid can flow;
a cut-off valve provided between the master cylinder and the gate-out valve on the first brake circuit;
a check valve arranged parallel to the cut-off valve and allowing only a flow of the brake fluid from the master cylinder;
a branch oil passage branching off from a point between the cut-off valve and the gate-out valve and connecting to the fluid suction part;
a fifth brake circuit branching off from a point between the master cylinder and the cut-off valve on the first brake circuit and connecting to the reservoir;
a stroke simulator valve provided on the fifth brake circuit and regulating an amount of the brake fluid that flows into the reservoir from the master cylinder; and
a hydraulic pressure control unit controlling the brake fluid pressure by operating the each valve and the pump in accordance with a regenerative operation state of the regenerative braking system.

2. The brake control apparatus as claimed in claim 1, further comprising:
a fluid suction part opening/closing valve on the branch oil passage.

3. The brake control apparatus as claimed in claim 1, further comprising:
a first pressure sensor that detects the brake fluid pressure at a point on the first brake circuit which is positioned at the master cylinder side with respect to a connection point of the first brake circuit with the fifth brake circuit; and
a second pressure sensor that detects a discharge pressure of the pump.

4. The brake control apparatus as claimed in claim 3, further comprising:
a brake operation state detection section that detects driver's brake operation state, and wherein
the hydraulic pressure control unit has a brake assist control section that when an increase in a brake operation amount is detected by the brake operation state detection section and a pressure detected by the first pressure sensor is smaller than a pressure detected by the second pressure sensor, increases a wheel cylinder pressure by the brake fluid in the fluid suction part.

5. The brake control apparatus as claimed in claim 3, further comprising:
a brake operation state detection section that detects driver's brake operation state, and wherein
the hydraulic pressure control unit has a brake assist control section that when an increase in a brake operation amount is detected by the brake operation state detection section and a regenerative braking force by the regenerative braking system lowers also a pressure detected by the first pressure sensor is greater than or equal to a pressure detected by the second pressure sensor, increases a wheel cylinder pressure by the brake fluid in the master cylinder and the brake fluid in the fluid suction part through the first brake circuit, the check valve and the third brake circuit by operating the stroke simulator valve in a valve closing direction, operating the gate-out valve in the valve closing direction and operating the pump.

6. The brake control apparatus as claimed in claim 5, wherein:
when pressure decrease of the wheel cylinder pressure is required during execution of the brake assist control by the brake assist control section, the hydraulic pressure control unit delivers the brake fluid in the wheel cylinder to the fluid suction part by operating the inflow valve in the valve closing direction, operating the outflow valve in a valve opening direction and operating the pump.

7. The brake control apparatus as claimed in claim 1, further comprising:
a brake operation state detection section that detects driver's brake operation state, and wherein
when the brake operation is detected by the brake operation state detection section and the regenerative braking system works, the hydraulic pressure control unit sucks up the brake fluid through the stroke simulator valve and the fifth brake circuit by operating the cut-off valve and the inflow valve in a valve closing direction and operating the pump, and pours the brake fluid flowing out from the master cylinder into the fluid suction part through the gate-out valve.

8. The brake control apparatus as claimed in claim 7, wherein:
when a regenerative braking amount of the regenerative braking system lowers, the hydraulic pressure control unit operates the stroke simulator valve in the valve closing direction and operates the inflow valve in a valve opening direction according to the lowering of the regenerative braking amount, and supplies the brake fluid in the fluid suction part to the wheel cylinder.

9. The brake control apparatus as claimed in claim 2, wherein:
when the regenerative braking system works while the brake fluid pressure generated by the driver's brake operation acts on the wheel cylinder, the hydraulic pressure control unit operates the inflow valve in a valve closing direction, operates the gate-out valve, the outflow valve and the fluid suction part opening/closing valve in a valve opening direction and operates the pump.

10. The brake control apparatus as claimed in claim 1, further comprising:
a brake operation state detection section that detects driver's brake operation state, and wherein
when an increase in driver's brake operation amount is detected by the brake operation state detection section while the regenerative braking system works, the hydraulic pressure control unit operates the inflow valve in a valve opening direction and increases the wheel cylinder pressure by the brake fluid in the fluid suction part.

11. The brake control apparatus as claimed in claim 1, further comprising:
an anti-lock brake control section that increase/decreases a braking torque to suppress a lock state of a wheel, and wherein
when a regenerative braking force is decreased by a braking torque decrease command by the anti-lock brake control section while the brake fluid pressure acts on the wheel cylinder, the hydraulic pressure control unit operates the inflow valve and the outflow valve in a valve closing direction and brings a wheel cylinder pressure in a holding state.

12. The brake control apparatus as claimed in claim 11, wherein:
the hydraulic pressure control unit operates the inflow valve in a valve opening direction in response to a braking torque increase command after the braking torque decrease command by the anti-lock brake control section, and increases the wheel cylinder pressure by the brake fluid in the fluid suction part.

13. The brake control apparatus as claimed in claim 12, wherein:
the hydraulic pressure control unit operates the outflow valve in the valve opening direction and operates the pump in response to the braking torque decrease command after the braking torque increase command by the anti-lock brake control section, and delivers the brake fluid in the wheel cylinder to the fluid suction part.

14. The brake control apparatus as claimed in claim 1, further comprising:
an anti-lock brake control section that increase/decreases a braking torque to suppress a lock state of a wheel, and wherein
the hydraulic pressure control unit operates the inflow valve in a valve closing direction, operates the outflow valve in a valve opening direction and operates the pump in response to a braking torque decrease command by the anti-lock brake control section when the brake fluid pressure acts on the wheel cylinder, and delivers the brake fluid in the wheel cylinder to the fluid suction part.

15. The brake control apparatus as claimed in claim 1, further comprising:
a vehicle behavior stabilization control section that detects a vehicle behavior and ensures stabilization of the vehicle behavior by independently controlling a braking torque of a certain wheel when detecting a predetermined behavior, and wherein
when detecting the predetermined behavior during a brake operation by regenerative braking of the regenerative braking system and braking of the hydraulic pressure control unit, the vehicle behavior stabilization control section increases a wheel cylinder pressure of the certain wheel by the brake fluid in the fluid suction part to increase the braking torque of the certain wheel.

16. A brake control apparatus used for a vehicle having a regenerative braking system, comprising:
a pump provided in a brake circuit;
a first brake circuit connecting a master cylinder that generates a brake fluid pressure by driver's brake operation and a wheel cylinder that is configured so that the brake fluid pressure acts on;
a second brake circuit connecting the first brake circuit and an outlet side of the pump;
a gate-out valve provided at a master cylinder side with respect to a connection point of the second brake circuit, on the first brake circuit;
a third brake circuit connecting a point positioned at the master cylinder side with respect to the gate-out valve and an inlet side of the pump, on the first brake circuit;
an inflow valve provided at a wheel cylinder side with respect to the connection point of the second brake circuit, on the first brake circuit;
a fourth brake circuit connecting a point positioned at the wheel cylinder side with respect to the inflow valve and the inlet side of the pump, on the first brake circuit;
an outflow valve provided on the fourth brake circuit;
a reservoir provided, on the fourth brake circuit, at the inlet side of the pump with respect to the outflow valve and connecting to the third brake circuit;
an accumulator into which the brake fluid can flow;
a cut-off valve provided between the master cylinder and the gate-out valve on the first brake circuit;
a check valve arranged parallel to the cut-off valve and allowing only a flow of the brake fluid from the master cylinder;
a branch oil passage branching off from a point between the cut-off valve and the gate-out valve and connecting to the accumulator;
a fifth brake circuit branching off from a point between the master cylinder and the cut-off valve on the first brake circuit and connecting to the reservoir;
a stroke simulator valve provided on the fifth brake circuit and regulating an amount of the brake fluid that flows into the reservoir from the master cylinder;
a fluid suction part opening/closing valve provided on the branch oil passage; and
a hydraulic pressure control unit controlling the brake fluid pressure by operating the each valve and the pump in accordance with a regenerative operation state of the regenerative braking system, and
when the regenerative braking system works, the brake fluid flowing out from the master cylinder by the driver's brake operation being stored in the accumulator by a pump operation of the pump through the fifth brake circuit, the stroke simulator valve, the fluid suction part opening/closing valve, the reservoir, the second brake circuit, the gate-out valve, the first brake circuit and the branch oil passage.

17. The brake control apparatus as claimed in claim 16, further comprising:
a first pressure sensor that detects the brake fluid pressure at a point on the first brake circuit which is positioned at the master cylinder side with respect to a connection point of the first brake circuit with the fifth brake circuit;
a second pressure sensor that detects a discharge pressure of the pump; and
a brake operation state detection section that detects driver's brake operation state, and wherein
the hydraulic pressure control unit has a brake assist control section that when an increase in a brake operation amount is detected by the brake operation state detection section and a regenerative braking force by the regenerative braking system lowers also a pressure detected by the first pressure sensor is greater than or equal to a pressure detected by the second pressure sensor, increases a wheel cylinder pressure by the brake fluid in the master cylinder and the brake fluid in the accumulator through the first brake circuit, the check valve and the third brake circuit by operating the stroke simulator valve in a valve closing direction, operating the gate-out valve in the valve closing direction and operating the pump.

18. A brake control apparatus used for a vehicle having a regenerative braking system, comprising:
a pump provided in a brake circuit;
a first brake circuit connecting a master cylinder that generates a brake fluid pressure by driver's brake operation and a wheel cylinder that is configured so that the brake fluid pressure acts on;
a second brake circuit connecting the first brake circuit and an outlet side of the pump;
a gate-out valve provided at a master cylinder side with respect to a connection point of the second brake circuit, on the first brake circuit;
a third brake circuit connecting a point positioned at the master cylinder side with respect to the gate-out valve and an inlet side of the pump, on the first brake circuit;
an inflow valve provided at a wheel cylinder side with respect to the connection point of the second brake circuit, on the first brake circuit;
a fourth brake circuit connecting a point positioned at the wheel cylinder side with respect to the inflow valve and the inlet side of the pump, on the first brake circuit;
an outflow valve provided on the fourth brake circuit;
a reservoir provided, on the fourth brake circuit, at the inlet side of the pump with respect to the outflow valve and connecting to the third brake circuit;
a fluid suction part into which the brake fluid can flow;
a cut-off valve provided between the master cylinder and the gate-out valve on the first brake circuit;
a check valve arranged parallel to the cut-off valve and allowing only a flow of the brake fluid from the master cylinder;
a branch oil passage branching off from a point between the cut-off valve and the gate-out valve and connecting to the fluid suction part;
a fifth brake circuit branching off from a point between the master cylinder and the cut-off valve on the first brake circuit and connecting to the reservoir;
a stroke simulator valve provided on the fifth brake circuit and regulating an amount of the brake fluid that flows into the reservoir from the master cylinder;
a fluid suction part opening/closing valve provided on the branch oil passage;
a first unit having a first housing that houses therein the cut-off valve, the fluid suction part, the fluid suction part opening/closing valve and the stroke simulator valve; and
a second unit having a second housing that houses therein the gate-out valve, the pump, the inflow valve and the outflow valve, and
the first unit and the second unit being connected at a point between the stroke simulator valve and the reservoir on the fifth brake circuit also at a point between a connection point of the first brake circuit with the third brake circuit and a connection point of the first brake circuit with the branch oil passage on the first brake circuit.

19. The brake control apparatus as claimed in claim 18, further comprising:
a hydraulic pressure control unit that controls the brake fluid pressure by operating the each valve and the pump in accordance with a regenerative operation state of the regenerative braking system.

20. The brake control apparatus as claimed in claim 19, further comprising:
a first pressure sensor that detects the brake fluid pressure at a point on the first brake circuit which is positioned at the master cylinder side with respect to a connection point of the first brake circuit with the fifth brake circuit;
a second pressure sensor that detects a discharge pressure of the pump; and
a brake operation state detection section that detects driver's brake operation state, and wherein
the hydraulic pressure control unit has a brake assist control section that when an increase in a brake operation amount is detected by the brake operation state detection section and a regenerative braking force by the regenerative braking system lowers also a pressure detected by the first pressure sensor is greater than or equal to a pressure detected by the second pressure sensor, increases a wheel cylinder pressure by the brake fluid in the master cylinder and the brake fluid in the fluid suction part through the first brake circuit, the check valve and the third brake circuit by operating the stroke simulator valve in a valve closing direction, operating the gate-out valve in the valve closing direction and operating the pump.
